(19) United States
(12) Patent Application Publication
(10) Pub. No.: US 2018/0356561 A1
(43) Pub. Date: Dec. 13, 2018

(54) GEL, GEL MANUFACTURING METHOD, LENS, CONTACT LENS SURFACE MODIFIER, POLYMERIZABLE COMPOSITION, AND POLYMER

(71) Applicants: JSR CORPORATION, Minato-ku (JP); JSR Life Sciences Corporation, Minato-ku (JP)

(72) Inventors: Satoshi HYUGAJI, Minato-ku (JP); Kazuhiro ISO, Minato-ku (JP); Kiyoshi SUDA, Minato-ku (JP); Naoki HAYASHI, Minato-ku (JP)

(73) Assignees: JSR CORPORATION, Minato-ku (JP); JSR Life Sciences Corporation, Minato-ku (JP)

(21) Appl. No.: 15/580,502

(22) PCT Filed: Jun. 7, 2016
(86) PCT No.: PCT/JP2016/066888

§ 371 Date: Dec. 7, 2017

(30) Foreign Application Priority Data
Jun. 8, 2015 (JP) 2015-115458

(51) Int. Cl. G02B 1/04; C08F 220/18; C08L 101/00; C08L 33/04; G02C 7/04; C08F 2/44; B29D 11/00

(52) U.S. Cl. CPC G02B 1/043; C08F 220/18; C08L 101/00; B29D 11/00067; G02C 7/049; C08F 2/44; C08L 33/04

(57) ABSTRACT

Provided is a gel that has excellent surface hydrophilicity, lubricity and antifouling property, and that is useful as, for example, a contact lens material.

A gel including:
a polymer a having 2.5 to 95 mass % of the following repeat unit (A), and 2.5 to 95 mass % of the following repeat unit (B), and
a polymer b obtained through polymerization of a hydrophilic monomer with a crosslinking agent.
(A) Hydrophilic repeat unit
(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

### TECHNICAL FIELD

The present invention relates to a gel, a gel manufacturing method, a lens, a contact lens surface modifier, a polymerizable composition and a polymer. More specifically, the present invention relates to a gel that is useful as, for example, a contact lens material, a gel manufacturing method, a lens, a contact lens surface modifier, a polymerizable composition and a polymer.

### BACKGROUND ART

Contact lenses are roughly classified into hydrous contact lenses (including soft contact lens) and non-hydrous contact lenses (including hard contact lens and soft contact lens), and the hydrous contact lenses generally have the merit of giving better wearing feeling than the non-hydrous contact lenses.

However, since conventional hydrous contact lenses have high hydrous property, there have been the problems of fast drying of the lens, deterioration in oxygen permeability, for example.

Given these circumstances, silicone hydrogel contact lenses having low hydrous property and high oxygen permeability have been developed, and such lenses recently have become the mainstream of contact lenses. However, since silicone chains contained in silicone hydrogel show hydrophobicity, the silicone hydrogel has the problems of poor wearing feeling and susceptibility to adhesion of lipid. If such a contact lens is continuously used with these problems unsolved, for example, asthenopia, fogging, deterioration in visual acuity correcting power, and adverse effects on cornea may arise.

Under such a background, techniques of modifying a lens material have been developed for the purpose of, for example, improving the hydrophilicity of the lens surface, preventing adhesion of dirt such as lipid, or giving the lubricity. For example, Patent Literature 1 discloses a technique of irradiating an ophthalmic lens surface with high frequency plasma or excimer, and bringing a hydrophilic monomer solution into contact with the lens surface, followed by irradiation with ultraviolet light to immobilize the hydrophilic monomer to the ophthalmic lens surface (graft polymerization). In Patent Literature 2, the lens surface is modified by covering the ophthalmic lens surface with carbon by plasma polymerization, and graft polymerizing a hydrophilic monomer.

Patent Literature 3 attempts to improve the hydrophilicity of the silicone hydrogel lens surface by bulk polymerization of a specific zwitter ion monomer together with a silicone monomer.

Besides the above, various cleaning solutions, storage solutions and coating agents for contact lens have been proposed for the purpose of improving the hydrophilicity of the contact lens surface. For example, as a cleaning solution for contact lens, a poly(oxyethylene)-poly(oxypropylene) block copolymer (poloxamer or poloxamine) which is a nonionic surfactant has been widely used heretofore (Patent Literature 4).

### CITATION LIST

### Patent Literature

Patent Literature 1: JP 2001-337298 A

Patent Literature 2: JP 2003-500507 A

Patent Literature 3: JP 4733471 B2

Patent Literature 4: U.S. Pat. No. 6,037,328

### SUMMARY OF INVENTION

### Technical Problem

However, in the techniques disclosed in Patent Literatures 1 and 2, equipment such as plasma irradiation equipment or ultraviolet light irradiation equipment is required, and the number of steps in process increases, so that the increase in the cost is indispensable. Also, after such a surface modifying step, it is necessary to conduct a cleaning step for removing unreacted monomers. In this cleaning, defensive means against microbial proliferation is indispensable, and extreme care is required. Therefore, the techniques disclosed in Patent Literatures 1 and 2 can be greatly problematic in terms of costs.

Further, the lens modified by the technique of Patent Literature 3 was not satisfactory in respect of the surface hydrophilicity, the lubricity, and the wearing feeling.

Further, the nonionic surfactant disclosed in Patent Literature 4 was insufficient in respect of the performance to hydrophilize the lens surface, and the performance to impart the lubricity. Although the performance to clean the lipid adhered to the lens surface was provided, the antifouling property was insufficient.

It is an object of the present invention to provide a gel having excellent surface hydrophilicity, lubricity and antifouling property that is useful as, for example, a contact lens material.

### Solution to Problem

The inventors of the present invention made extensive investigations. As a result, they found that a gel containing a specific polymer in addition to a polymer that is obtained through polymerization of a hydrophilic monomer with a crosslinking agent, has excellent surface hydrophilicity, lubricity and antifouling property, and is useful as, for example, a contact lens material, and accomplished the present invention.

The present invention provides the following <1> to <14>.

<1> A gel including:

a polymer a having 2.5 to 95 mass % of the following repeat unit (A), and 2.5 to 95 mass % of the following repeat unit (B), and

a polymer b obtained through polymerization of a hydrophilic monomer with a crosslinking agent (hereinafter, also referred to as a gel of the present invention).

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

<2> The gel according to <1>, wherein the hydrophilic monomer is polymerized with the crosslinking agent in the presence of the polymer a.

<3> The gel according to <1> or <2>, wherein the repeat unit (A) is one or more selected from the group consisting of repeat unit (A-1) having a polyoxyalkylene group at a side chain thereof, the side chain having a terminal formed of a hydrogen atom or an alkyl group having 1 to 4 carbon atoms, repeat unit (A-2) expressed by the following formula (3), repeat unit (A-3) expressed by the following formula (4), repeat unit (A-4) expressed by the following formula (5), repeat unit (A-5) expressed by the following formula (6), betainic repeat unit (A-6) expressed by the following formula (7), anionic repeat unit (A-7), and cationic repeat unit (A-8) expressed by the following formula (8):

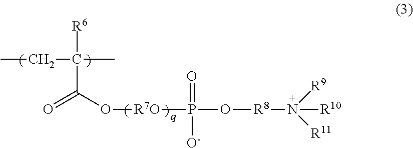

[In formula (3),

R⁶ represents a hydrogen atom or a methyl group,

R⁷ represents an alkanediyl group having 2 to 4 carbon atoms,

R⁸ represents an alkanediyl group having 1 to 10 carbon atoms,

R⁹, R¹⁰ and R¹¹ independently represent a hydrogen atom or a hydrocarbon atom having 1 to 8 carbon atoms,

q represents 1 to 10 at an average value.]

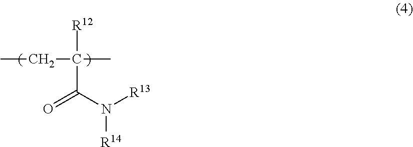

[In formula (4),

R¹² represents a hydrogen atom or a methyl group, R¹³ and R¹⁴ independently represent a hydrogen atom, an alkyl group having 1 to 6 carbon atoms or a hydroxyalkyl group.]

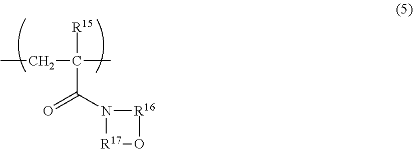

[In formula (5),

R¹⁵ represents a hydrogen atom or a methyl group,

R¹⁶ and R¹⁷ independently represent an alkanediyl group having 1 to 3 carbon atoms.]

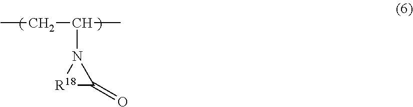

[In formula (6),

R¹⁸ represents an alkanediyl group having 1 to 5 carbon atoms.]

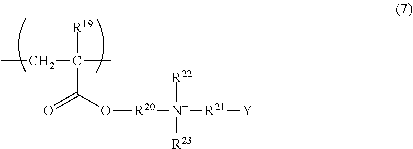

[In formula (7),

Y represents —(C═O)O⁻, —(O═S═O)O⁻, —O(O═S═O)O⁻, —(S═O)O⁻, —O(S═O)O—, —OP(═O)(OR²⁴)O⁻, —OP(═O)(R²⁴)O⁻, —P(═O)(OR²⁴)O⁻, or —P(═O)(R²⁴)O⁻ (R²⁴ represents an alkyl group having 1 to 3 carbon atoms),

R¹⁹ represents a hydrogen atom or a methyl group,

R²⁰ and R²¹ independently represent a bivalent organic group having 1 to 10 carbon atoms, and

R²² and R²³ independently represent a hydrocarbon having 1 to 10 carbon atoms.]

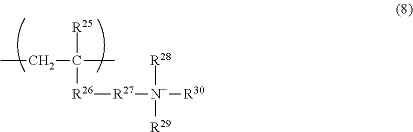

[In formula (8),

R²⁵ represents a hydrogen atom or a methyl group,

R²⁶ represents —O—, *—(C═O)—O—, *—(C═O)—NR³¹—, *—NR³¹—(C═O)— (R³¹ represents a hydrogen atom or an organic group having 1 to 10 carbon atoms, * represents a position of binding with a carbon atom to which R²⁵ in formula (8) binds) or a phenylene group,

R²⁷ represents a bivalent organic group having 1 to 10 carbon atoms, and

R²⁸, R²⁹ and R³⁰ independently represent a hydrocarbon having 1 to 10 carbon atoms.]

<4> The gel according to <3>, wherein the repeat unit (A-1) is expressed by the following formula (2):

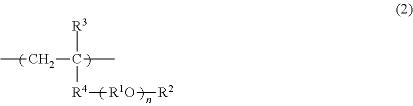

[In formula (2),

R¹ represents an alkanediyl group having 2 to 4 carbon atoms,

R² represents a hydrogen atom or an alkyl group having 1 to 4 carbon atoms,

R³ represents a hydrogen atom or a methyl group,

R⁴ represents —O—, *—(C═O)—O—, *—(C═O)—NR⁵—, *—NR⁵—(C═O)— (R⁵ represents a hydrogen atom or an organic group having 1 to 10 carbon atoms, * represents a position of binding with a carbon atom to which R³ in formula (2) binds) or a phenylene group, and

n represents 2 to 100 at an average value.]

<5> The gel according to any one of <1> to <4>, wherein the repeat unit (B) is a repeat unit having a polyoxyalkylene group at a side chain thereof, and the terminal of the side chain is formed of an alkyl group having 5 to 30 carbon atoms, or an alkanoyl group having 5 to 30 carbon atoms.

<6> The gel according to any one of <1> to <4>, wherein the repeat unit (B) is expressed by the following formula (10):

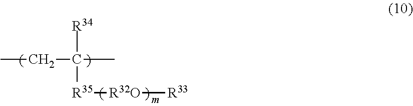

[In formula (10),

R³² represents an alkanediyl group having 2 to 4 carbon atoms,

R³³ represents an alkyl group having 5 to 30 carbon atoms, an alkanoyl group having 5 to 30 carbon atoms, or an aryl group,

R³⁴ represents a hydrogen atom or a methyl group,

R³⁵ represents —O—, **—(C═O)—O—, **—(C═O)—NR³⁶—, **—NR³⁶—(C═O)— (R³⁶ represents a hydrogen atom or an organic group having 1 to 10 carbon atoms, ** represents a position of binding with a carbon atom to which R³⁴ in formula (10) binds) or a phenylene group, and

m represents 2 to 100 at an average value.]

<7> The gel according to any one of <1> to <6>, wherein the polymer a further has 60% by mass or less of one or more repeat unit (C) selected from the group consisting of repeat unit (C-1) expressed by the following formula (11) and repeat unit (C-2) having a group expressed by the following formula (12) at the terminal of a side chain:

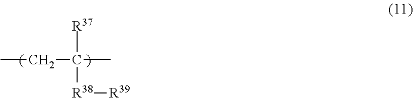

[In formula (11),

R³⁷ represents a hydrogen atom or a methyl group,

R³⁸ represents —O—, ***—(C═O)—O—, ***—(C═O)—NR⁴⁰—, ***—NR⁴⁰—(C═O)— (R⁴⁰ represents a hydrogen atom or an organic group having 1 to 10 carbon atoms, *** represents a position of binding with a carbon atom to which R³⁷ in formula (11) binds) or a phenylene group, and

R³⁹ represents a hydrocarbon group having 4 to 30 carbon atoms.]

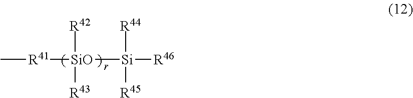

[In formula (12),

R⁴¹ represents a bivalent organic group having 1 to 10 carbon atoms,

R⁴2 and R⁴³ independently represent an organic group having 1 to 10 carbon atoms,

R⁴⁴, R⁴⁵ and R⁴⁶ independently represent —OSi(R⁴⁹)₃ (each of R⁴⁹ independently represents a hydrogen atom or an organic group having 1 to 8 carbon atoms) or an organic group having 1 to 10 carbon atoms, and

r represents 0 to 200 at an average value.]

<8> The gel according to any one of <1> to <7>, wherein the polymer a is a non-network polymer.

<9> The gel according to any one of <1> to <8>, containing 0.01 to 40 mass % of the polymer a.

<10> The gel according to any one of <1> to <9>, further containing a silicone compound.

<11> The gel according to any one of <1> to <9>, wherein the polymer b is obtained through polymerization of a silicone compound having a polymerizable functional group with the hydrophilic monomer and the crosslinking agent.

<12> A method for manufacturing a gel containing a polymer, including:

polymerizing a hydrophilic monomer with a crosslinking agent to give a polymer, in the presence of a polymer a having the following repeat unit (A): 2.5 to 95 mass % and the following repeat unit (B): 2.5 to 95 mass % (hereinafter, also referred to as a method for manufacturing a gel of the present invention).

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

<13> A lens including the gel according to any one of <1> to <11> (hereinafter, also referred to as a lens of the present invention).

<14> The lens according to <13>, wherein the lens is a contact lens.

<15> A contact lens surface modifier including:

a polymer a having 2.5 to 95 mass % of the following repeat unit (A), and 2.5 to 95 mass % of the following repeat unit (B) (hereinafter, also referred to as a contact lens surface modifier of the present invention).

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

<16> A polymerizable composition including:

a polymer a having 2.5 to 95 mass % of the following repeat unit (A), and 2.5 to 95 mass % of the following repeat unit (B), a hydrophilic monomer, and

a crosslinking agent (hereinafter, also referred to as a polymerizable composition of the present invention).

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

<17> A polymer having 2.5 to 95 mass % of the following repeat unit (A), and 2.5 to 95 mass % of the following repeat unit (B) (hereinafter, also referred to as a polymer of the present invention, but the same meanings as polymer a).

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

### Advantageous Effects of Invention

The gel of the present invention has excellent surface hydrophilicity, lubricity and antifouling property, and has high sustainability of these properties. Therefore, the gel of the present invention is useful also as, for example, a contact lens material.

According to the manufacturing method of the gel of the present invention, it is possible to conveniently manufacture a gel having excellent surface hydrophilicity, lubricity and antifouling property at low cost.

The lens of the present invention has excellent surface hydrophilicity, lubricity and antifouling property, and has high sustainability of these properties.

By using the polymer, the contact lens surface modifier of the present invention, it is possible to obtain a lens having excellent surface hydrophilicity, lubricity and antifouling property, and having high sustainability of these properties. By using the polymerizable composition of the present invention, it is possible to obtain a gel having excellent surface hydrophilicity, lubricity and antifouling property, and having high sustainability of these properties.

### DESCRIPTION OF EMBODIMENTS

### [Gel]

The gel of the present invention is characterized by containing polymer a having 2.5 to 95 mass % of repeat unit (A), and 2.5 to 95 mass % of repeat unit (B) (hereinafter, also simply referred to as polymer a) and polymer b obtained through polymerization of a hydrophilic monomer with a crosslinking agent (hereinafter, also simply referred to as polymer b).

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

The statement that specifies a product by a manufacturing process of the product in this description is due to presence of “impossible or impractical circumstances”.

<Polymer a>

Polymer a used in the gel of the present invention has 2.5 to 95 mass % of repeat unit (A), and 2.5 to 95 mass % of repeat unit (B). Polymer a functions as a modifier for modifying, for example, the contact lens surface, and is useful as, for example, a contact lens surface modifying polymer, and a contact lens surface modifier.

### (Repeat Unit (A))

Repeat unit (A) can be a hydrophilic repeat unit, and is preferably one or more selected from the group consisting of repeat unit (A-1) having a polyoxyalkylene group at a side chain thereof, the side chain having a terminal formed of a hydrogen atom or an alkyl group having 1 to 4 carbon atoms, repeat unit (A-2) expressed by the following formula (3), repeat unit (A-3) expressed by the following formula (4), repeat unit (A-4) expressed by the following formula (5), repeat unit (A-5) expressed by the following formula (6), betainic repeat unit (A-6) expressed by the following formula (7), anionic repeat unit (A-7), and cationic repeat unit (A-8) expressed by the following formula (8).

The term hydrophilic used herein means that the object has strong affinity with water. To be more specific, for a homopolymer composed of one kind of repeat unit (the one having a number average molecular weight as measured by a measuring method of Example of about 10000), if 1 g or more polymer is dissolved per 100 g of pure water at a normal temperature (25° C.), the repeat unit is regarded as hydrophilic.

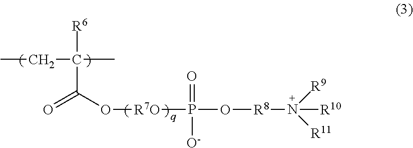

[In formula (3),

R⁶ represents a hydrogen atom or a methyl group,

R⁷ represents an alkanediyl group having 2 to 4 carbon atoms,

R⁸ represents an alkanediyl group having 1 to 10 carbon atoms,

R⁹, R¹⁰ and R¹¹ independently represent a hydrogen atom or a hydrocarbon atom having 1 to 8 carbon atoms, and

q represents 1 to 10 at an average value.]

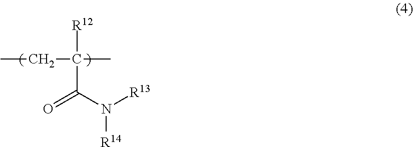

[In formula (4),

R¹² represents a hydrogen atom or a methyl group, and

R¹³ and R¹⁴ independently represent a hydrogen atom, an alkyl group having 1 to 6 carbon atoms or a hydroxyalkyl group.]

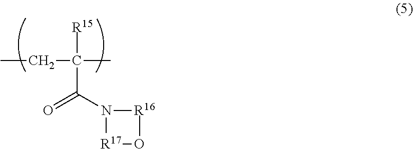

[In formula (5),

R¹¹ represents a hydrogen atom or a methyl group, and

R¹⁶ and R¹⁷ independently represent an alkanediyl group having 1 to 3 carbon atoms.]

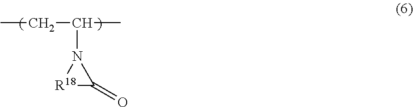

[In formula (6),

R¹⁸ represents an alkanediyl group having 1 to 5 carbon atoms.]

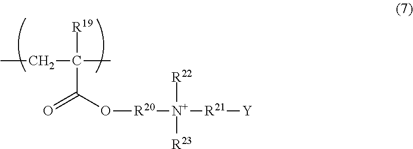

[In formula (7),

Y represents —(C═O)O⁻, —(O═S═O)O⁻, —(O═S═O)O⁻, —(S═O)O⁻, —O(S═O)O⁻, —OP(═O)(OR²⁴)O⁻, —OP(═O)(R²⁴)O⁻, —P(═O)(OR²⁴)O⁻, or —P(═O)(R²⁴)O⁻ (R²⁴ represents an alkyl group having 1 to 3 carbon atoms),

R¹⁹ represents a hydrogen atom or a methyl group,

R²⁰ and R²¹ independently represent a bivalent organic group having 1 to 10 carbon atoms, and

R²² and R²³ independently represent a hydrocarbon group having 1 to 10 carbon atoms.]

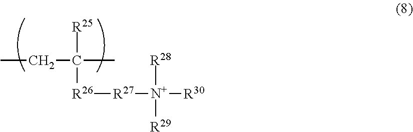

[In formula (8),

R²⁵ represents a hydrogen atom or a methyl group,

R²⁶ represents —O—, *—(C═O)—O—, *—(C═O)—NR³¹—, *—NR³¹—(C═O)— (R³¹ represents a hydrogen atom or an organic group having 1 to 10 carbon atoms, * represents a position of binding with a carbon atom to which R²⁵ in formula (8) binds) or a phenylene group,

R²⁷ represents a bivalent organic group having 1 to 10 carbon atoms, and

R²⁸, R²⁹ and R³⁰ independently represent a hydrocarbon group having 1 to 10 carbon atoms.]

### (Repeat Unit (A-1))

Repeat unit (A-1) has a polyoxyalkylene group at a side chain thereof, the side chain having a terminal formed of a hydrogen atom or an alkyl group having 1 to 4 carbon atoms.

As repeat unit (A-1), a repeat unit containing a structure expressed by the following formula (1) at a side chain thereof is recited. As a polymer species that is to be a repeat unit having a structure expressed by the formula (1) at a side chain thereof, known polymer species can be used. Among these, for example, (meth)acrylate-based polymer species, (meth)acrylamide-based polymer species, and styrene-based polymer species are preferred. Among these, the repeat unit expressed by the following formula (2) is preferred.

R¹OₙR² (1)

[In formula (1),

R¹ represents an alkanediyl group having 2 to 4 carbon atoms,

R² represents a hydrogen atom or an alkyl group having 1 to 4 carbon atoms, and

n represents 2 to 100 at an average value.]

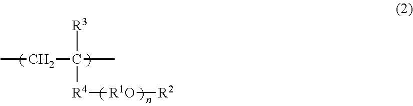

[In formula (2),

R³ represents a hydrogen atom or a methyl group,

R⁴ represents —O—, *—(C═O)—O—, *—(C═O)—NR⁵—, *—NR⁵—(C═O)— (R⁵ represents a hydrogen atom or an organic group having 1 to 10 carbon atoms, * represents a position of binding with a carbon atom to which R³ in formula (2) binds) or a phenylene group, and

other signs have the same meanings as in formula (1).]

Here, each sign in formulas (1) and (2) will be described.

R¹ represents an alkanediyl group having 2 to 4 carbon atoms, and n R¹s may be identical or different from each other.

The number of carbon atoms in the alkanediyl group represented by R¹ is preferably 2 or 3, more preferably 2.

An alkanediyl group represented by R¹ may be straight-chained or branched-chained, and concrete examples include an ethane-1,2-diyl group, a propane-1,2-diyl group, a propane-1,3-diyl group, a propane-2,2-diyl group, a butane-1,2-diyl group, a butane-1,3-diyl group, and a butane-1,4-diyl group. Among these, from the viewpoint of availability, hydrophilizing ability, for example, an ethane-1,2-diyl group is preferred.

R² represents a hydrogen atom or an alkyl group having 1 to 4 carbon atoms. The number of carbon atoms in the alkyl group represented by R² is preferably 1 to 3, more preferably 1 or 2, further preferably 1 from the viewpoint of availability, hydrophilizing ability, for example. The alkyl group represented by R² may be straight-chained or branched-chained, and concrete examples include a methyl group, an ethyl group, a n-propyl group, an isopropyl group, a n-butyl group, an isobutyl group, a sec-butyl group, and a tert-butyl group.

Among the R², a hydrogen atom or an alkyl group having 1 to 3 carbon atoms is preferred, a hydrogen atom or an alkyl group having 1 or 2 carbon atoms is more preferred, a hydrogen atom or a methyl group is further preferred, and a methyl group is particularly preferred from the viewpoint of availability, hydrophilizing ability, for example.

R⁴ represents —O—, *—(C═O)—O—, *—(C═O)—NR⁵—, *—NR⁵—(C═O)— or a phenylene group. Examples of the phenylene group include a 1,2-phenylene group, a 1,3-phenylene group, and a 1,4-phenylene group.

The number of carbon atoms in the organic group represented by R⁵ is 1 to 10, preferably 1 to 6. As the organic group, a hydrocarbon group can be recited. The hydrocarbon group is a concept involving an aliphatic hydrocarbon group, an alicyclic hydrocarbon group, and an aromatic hydrocarbon group.

The aliphatic hydrocarbon group in R⁵ may be straight-chained or branched-chained, and concrete examples include alkyl groups such as a methyl group, an ethyl group, a n-propyl group, an isopropyl group, a n-butyl group, an isobutyl group, a sec-butyl group, a tert-butyl group, a pentyl group, a hexyl group, a heptyl group, an octyl group, a nonyl group, and a decyl group.

The alicyclic hydrocarbon group is roughly classified into a monocyclic alicyclic hydrocarbon group and a bridged cyclic hydrocarbon group. Examples of the monocyclic alicyclic hydrocarbon group include cycloalkyl groups such as a cyclopropyl group, and a cyclohexyl group. Examples of the bridged cyclic hydrocarbon group include an isobornyl group.

Examples of the aromatic hydrocarbon group include aryl groups such as a phenyl group.

Among R⁴ as described above, *—(C═O)—O—, and a phenylene group are preferred, and *—(C═O)—O— is particularly preferred from the viewpoint of hydrophilizing ability, for example.

n represents 2 to 100 at an average value, preferably 4 to 90 at an average value, more preferably 8 to 90 at an average value, further preferably 8 to 60 at an average value, further preferably 8 to 40 at an average value, particularly preferably 9 to 25 at an average value.

Each “average value” as used herein can be measured by NMR. For example, regarding the structure of formula (2), an average value of n can be calculated by measuring ¹H-NMR, and comparing the integrated values of respective proton peaks between the alkanediyl group having 2 to 4 carbon atoms of R¹ and the methyl group of the terminal of the alkyl group having 1 to 4 carbon atoms of R²

Examples of the monomer from which such repeat unit (A-1) is derived include polyethylene glycol (meth)acrylate, polypropylene glycol (meth)acrylate, polyethylene glycol polypropylene glycol (meth)acrylate, polyethylene glycol polytetramethyleneglycol (meth)acrylate, polypropylene glycol polytetramethyleneglycol (meth)acrylate, methoxypolyethylene glycol (meth)acrylate, and ethoxypolyethylene glycol (meth)acrylate, and repeat unit (A-1) can be derived by using these singly or in combination of two or more kinds. Among these, polyethylene glycol (meth)acrylate, and methoxypolyethylene glycol (meth)acrylate are preferred.

### (Repeat Unit (A-2))

Repeat unit (A-2) is expressed by the above formula (3).

In formula (3), R⁷ represents an alkanediyl group having 2 to 4 carbon atoms. When there is a plurality of R⁷s, the R⁷s may be identical or different from each other.

The number of carbon atoms in the alkanediyl group represented by R⁷ is preferably 2 or 3, more preferably 2.

The alkanediyl group represented by R⁷ may be straight-chained or branched-chained, and concrete examples include an ethane-1,2-diyl group, a propane-1,2-diyl group, a propane-1,3-diyl group, a propane-2,2-diyl group, a butane-1,2-diyl group, a butane-1,3-diyl group, and a butane-1,4-diyl group. Among these, an ethane-1,2-diyl group is preferred from the viewpoint of availability, hydrophilizing ability, for example.

R⁸ represents an alkanediyl group having 1 to 10 carbon atoms.

The number of carbon atoms in the alkanediyl group represented by R⁸ is preferably 1 to 6, more preferably 1 to 4, further preferably 2 or 3, particularly preferably 2.

The alkanediyl group represented by R⁸ may be straight-chained or branched-chained, and preferred concrete examples include those recited for the alkanediyl group represented by R⁷.

R⁹, R¹⁰ and R¹¹ independently represent a hydrogen atom or a hydrocarbon group having 1 to 8 carbon atoms, with a hydrocarbon group having 1 to 8 carbon atoms being preferred. The number of carbon atoms in such a hydrocarbon group is preferably 1 to 4, more preferably 1 or 2, particularly preferably 1.

Examples of the hydrocarbon group include an alkyl group; an aryl group such as a phenyl group; and an aralkyl group such as a benzyl group, and an alkyl group is preferred.

The alkyl group may be straight-chained or branched-chained, and preferred concrete examples include a methyl group, an ethyl group, a n-propyl group, an isopropyl group, a n-butyl group, an isobutyl group, a sec-butyl group, and a tert-butyl group.

q represents 1 to 10 at an average value, preferably 1 to 7 at an average value, more preferably 1 to 4 at an average value, further preferably 1 at an average value.

Repeat unit (A-2) may have an alkali metal ion such as a sodium ion or a potassium ion, an alkali earth metal ion such as a calcium ion or a magnesium ion, an ammonium ion, a hydrogen ion, or a counter ion such as a hydroxide ion.

Examples of the monomer from which such repeat unit (A-2) is derived include 2-(meth)acryloyloxyethyl-2′-(trimethylammonio)ethyl phosphate(2-(meth)acryloyloxyethylphosphorylcholine), 3-(meth)acryloyloxypropyl-2′-(trimethylammonio)ethyl phosphate, 4-(meth)acryloyloxybutyl-2′-(trimethylammonio)ethyl phosphate, 2-(meth)acryloyloxyethoxyethyl-2′-(trimethylammonio)ethyl phosphate, 2-(meth)acryloyloxydiethoxyethyl-2′-(trimethylammonio)ethyl phosphate, 2-(meth)acryloyloxyethyl-2′-(triethylammonio)ethyl phosphate, and 2-(meth)acryloyloxyethyl-2′-(tributylammonio)ethyl phosphate, and repeat unit (A-2) can be derived by using these singly or in combination of two or more kinds.

### (Repeat Unit (A-3))

Repeat unit (A-3) is expressed by the above formula (4).

In formula (4), R¹³ and R¹⁴ independently represent a hydrogen atom, an alkyl group having 1 to 6 carbon atoms, or a hydroxyalkyl group.

The number of carbon atoms in the alkyl group represented by R¹³, R¹⁴ is preferably 1 to 3.

The alkyl group represented by R¹³, R¹⁴ may be straight-chained or branched-chained, and preferred concrete examples include a methyl group, an ethyl group, a n-propyl group, and an isopropyl group.

The number of carbon atoms in the hydroxyalkyl group represented by R¹³, R¹⁴ is preferably 1 to 6, more preferably 1 to 3. The alkyl group included in the hydroxyalkyl group may be straight-chained or branched-chained, and preferred concrete examples of the hydroxyalkyl group include a hydroxymethyl group, a hydroxyethyl group, a hydroxypropyl group, and a hydroxyisopropyl group. The substitution with a hydroxy group in the hydroxyalkyl group may occur in any position.

Examples of the monomer from which such repeat unit (A-3) is derived include dimethyl(meth)acrylamide, diethyl(meth)acrylamide, N-isopropyl(meth)acrylamide, N-(hydroxymethyl)(meth)acrylamide, and N-(2-hydroxyethyl)(meth)acrylamide, and repeat unit (A-3) can be derived by using these singly or in combination of two or more kinds.

### (Repeat Unit (A-4))

Repeat unit (A-4) is expressed by the above formula (5).

In formula (5), R¹⁶ and R¹⁷ independently represent an alkanediyl group having 1 to 3 carbon atoms. The number of carbon atoms in the alkanediyl group is preferably 1 to 2.

While the alkanediyl group may be straight-chained or branched-chained, it is preferably a straight chain. Preferred concrete examples include a methane-1,1-diyl group, and an ethane-1,2-diyl group.

Examples of the monomer from which such repeat unit (A-4) is derived include 4-(meth)acryloylmorpholine.

### (Repeat Unit (A-5))

Repeat unit (A-5) is expressed by the above formula (6).

In formula (6), R¹⁸ represents an alkanediyl group having 1 to 5 carbon atoms. The number of carbon atoms in the alkanediyl group is preferably 3 to 5.

While the alkanediyl group may be straight-chained or branched-chained, it is preferably a straight chain. Preferred concrete examples include a propane-1,3-diyl group, a butane-1,4-diyl group, and a pentane-1,5-diyl group.

Examples of the monomer from which such repeat unit (A-5) is derived include 1-vinyl-2-pyrrolidone, and N-vinyl-ε-caprolactam, and repeat unit (A-5) can be derived by using these singly or in combination of two or more kinds.

### (Repeat Unit (A-6))

Repeat unit (A-6) is a betainic repeat unit expressed by the above formula (7).

In formula (7), as Y, —(C═O)O⁻ is preferred. Examples of the alkyl group represented by R²⁴ include a methyl group, an ethyl group, a n-propyl group, and an isopropyl group.

In formula (7), R²⁰ and R²¹ independently represent a bivalent organic group having 1 to 10 carbon atoms. The number of carbon atoms in the bivalent organic group is preferably 1 to 8, more preferably 1 to 6.

As the bivalent organic group, a bivalent hydrocarbon group is preferred, and a bivalent aliphatic hydrocarbon group is more preferred. The bivalent aliphatic hydrocarbon group may be straight-chained or branched-chained. As the bivalent aliphatic hydrocarbon group, an alkanediyl group is preferred. Examples include a methane-1,1-diyl group, an ethane-1,2-diyl group, a propane-1,1-diyl group, a propane-1,2-diyl group, a propane-1,3-diyl group, a propane-2,2-diyl group, a butane-1,4-diyl group, a pentane-1,5-diyl group, and a hexane-1,6-diyl group.

In formula (7), R²² and R²³ independently represent a hydrocarbon having 1 to 10 carbon atoms. The number of carbon atoms in the hydrocarbon group is preferably 1 to 6, more preferably 1 to 4.

Examples of the hydrocarbon group represented by R²² and R²³ include an alkyl group; an aryl group such as a phenyl group; and an aralkyl group such as a benzyl group, and an alkyl group is preferred. The alkyl group may be straight-chained or branched-chained, and examples include a methyl group, an ethyl group, a n-propyl group, an isopropyl group, a n-butyl group, an isobutyl group, a sec-butyl group, and a tert-butyl group.

Repeat unit (A-6) may have an alkali metal ion such as a sodium ion or a potassium ion, an alkali earth metal ion such as a calcium ion or a magnesium ion, an ammonium ion, a hydrogen ion, or a counter ion such as a hydroxide ion.

Examples of the monomer from which such repeat unit (A-6) is derived include (meth)acrylate-based monomers such as N-(meth)acryloyloxyethyl-N,N-dimethylammonium-α-N-methylcarboxybetaine, and N-(meth)acryloyloxyethyl-N,N-dimethylammonium-α-N-propyl sulfobetaine, and repeat unit (A-6) can be derived by using these singly or in combination of two or more kinds.

### (Repeat Unit (A-7))

Repeat unit (A-7) is an anionic repeat unit.

As repeat unit (A-7), a repeat unit having an acidic group can be recited.

As repeat unit (A-7), a unit derived from a monomer containing an ethylenic unsaturated bond is preferred from the viewpoint of ease of introduction and safety.

Examples of the acidic group include a carboxy group, a sulfo group, a phosphate group or salts thereof, and one of these can be contained, or two or more of these can be contained. Examples of the salts include alkali metal salts such as sodium salts and potassium salts; alkali earth metal salts such as magnesium salts and calcium salts; ammonium salts; and organic ammonium salts.

Examples of the monomer from which such repeat unit (A-7) is derived include unsaturated dicarboxylic acids such as fumaric acid, maleic acid, and itaconic acid or salts thereof; unsaturated carboxylic acid such as (meth)acrylic acid or salts thereof; sulfo group-containing polymerizable unsaturated monomers such as ethylene sulfonic acid, allylsulfonic acid, methallylsulfonic acid, 2-sulfoethyl (meth)acrylate and 2-acrylamide-2-methylpropanesulfonic acid or salts thereof; phosphate group-containing polymerizable unsaturated monomers such as 2-(meth)acryloyloxyethyl acid phosphate and 2-(meth)acryloyloxypropyl acid phosphate or salts thereof. The monomer from which repeat unit (A-7) is derived can also be obtained by using, for example, a hydrolysate of acrylic acid ester; a hydrolysate of acid anhydride of unsaturated dicarboxylic acid such as maleic anhydride or itaconic anhydride; or an adduct of an acidic group-containing thiol to an epoxy group of glycidyl methacrylate or (4-vinylbenzyl)glycidyl ether. Repeat unit (A-7) can be derived by using these singly or in combination of two or more kinds.

Among these, acrylic acid, and methacrylic acid are preferred from the viewpoint of ease of introduction and reactivity.

### (Repeat Unit (A-8))

Repeat unit (A-8) is a cationic repeat unit expressed by the above formula (8).

In formula (8), R²⁶ represents —O—, *—(C═O)—O—, *—(C═O)—NR³¹—, *—NR³¹—(C═O)— or a phenylene group. Examples of the phenylene group include a 1,2-phenylene group, a 1,3-phenylene group, and a 1,4-phenylene group.

The number of carbon atoms in the organic group represented by R³¹ is 1 to 10, preferably 1 to 6. As the organic group, a hydrocarbon group can be recited. The hydrocarbon group is a concept involving an aliphatic hydrocarbon group, an alicyclic hydrocarbon group, and an aromatic hydrocarbon group.

The aliphatic hydrocarbon group in R³¹ may be straight-chained or branched-chained, and concrete examples include alkyl groups such as a methyl group, an ethyl group, a n-propyl group, an isopropyl group, a n-butyl group, an isobutyl group, a sec-butyl group, a tert-butyl group, a pentyl group, a hexyl group, a heptyl group, an octyl group, a nonyl group, and a decyl group.

The alicyclic hydrocarbon group is roughly classified into a monocyclic alicyclic hydrocarbon group and a bridged cyclic hydrocarbon group. Examples of the monocyclic alicyclic hydrocarbon group include cycloalkyl groups such as a cyclopropyl group, and a cyclohexyl group. Examples of the bridged cyclic hydrocarbon group include an isobornyl group.

Examples of the aromatic hydrocarbon group include aryl groups such as a phenyl group.

In formula (8), R²⁷ represents a bivalent organic group having 1 to 10 carbon atoms. The number of carbon atoms in the bivalent organic group is preferably 1 to 8, more preferably 1 to 6.

As the bivalent organic group, a bivalent hydrocarbon group is preferred, and a bivalent aliphatic hydrocarbon group is more preferred. The bivalent aliphatic hydrocarbon group may be straight-chained or branched-chained. As the bivalent aliphatic hydrocarbon group, an alkanediyl group is preferred. Examples include a methane-1,1-diyl group, an ethane-1,2-diyl group, a propane-1,1-diyl group, a propane-1,2-diyl group, a propane-1,3-diyl group, a propane-2,2-diyl group, a butane-1,4-diyl group, a pentane-1,5-diyl group, and a hexane-1,6-diyl group.

In formula (8), R²⁸, R²⁹ and R³⁰ independently represent a hydrocarbon having 1 to 10 carbon atoms. The number of carbon atoms in the hydrocarbon group is preferably 1 to 6, more preferably 1 to 4.

Examples of the hydrocarbon group represented by R²⁸, R²⁹ and R³⁰ include an alkyl group; an aryl group such as a phenyl group; and an aralkyl group such as a benzyl group, and an alkyl group is preferred. The alkyl group may be straight-chained or branched-chained, and examples include a methyl group, an ethyl group, a n-propyl group, an isopropyl group, a n-butyl group, an isobutyl group, a sec-butyl group, and a tert-butyl group.

Repeat unit (A-8) may have a counter ion. Examples of the counter ion include halogeno ions such as chlorine ion, bromine ion, and iodine ion; hydrogen sulfate ion; alkyl sulfate ions such as methyl sulfate ion and ethyl sulfate ion; alkyl sulfonate ion; aryl sulfonate ions such as dodecylbenzene sulfonate ion, and para-toluene sulfonate ion; alkenyl sulfonate ions such as sodium 2-methyl-2-propene-1-sulfonate; and carboxylate ion such as acetate ion.

Preferred concrete examples of monomer species from which repeat unit (A-8) is derived include (meth)acrylates, and (meth)acrylamides.

Examples of monomer species of (meth)acrylates include ((meth)acryloyloxyC₁₋₁₀alkyl)triC₁₋₁₀alkyl ammonium chloride such as ((meth)acryloyloxyethyl)trimethyl ammonium chloride, and ((meth)acryloyloxyC₁₋₁₀alkyl)diC₁₋₁₀alkylC₆₋₁₀aralkyl ammonium chloride such as ((meth)acryloyloxyethyl)dimethylbenzyl ammonium chloride. Examples of monomer species of (meth)acrylamides include (3-(meth)acrylamideC₁₋₁₀alkyl)triC₁₋₁₀alkyl ammonium chloride such as (3-(meth)acrylamidepropyl)trimethyl ammonium chloride, and (3-(meth)acrylamideC₁₋₁₀alkyl)diC₁₋₁₀alkylC₆₋₁₀aralkyl ammonium chloride such as (3-(meth)acrylamidepropyl)dimethylbenzyl ammonium chloride. Repeat unit (A-8) can be derived by using these singly or in combination of two or more kinds.

Among these, (3-(meth)acrylamidepropyl)trimethyl ammonium chloride is preferred from the viewpoint of ease of introduction and reactivity.

Among these repeat units (A-1) to (A-8), from the viewpoint of hydrophilizing ability, antifouling property imparting effect and lubricity imparting effect, repeat unit (A-1), repeat unit (A-3), repeat unit (A-4), repeat unit (A-6), and repeat unit (A-7) are preferred, and repeat unit (A-1), repeat unit (A-3), repeat unit (A-6), and repeat unit (A-7) are more preferred. Among these, as repeat unit (A), the following (i) to (ii) are preferred and (ii) is particularly preferred from the viewpoint of hydrophilizing ability and lubricity imparting effect.

(i) one or more selected from the group consisting of repeat units (A-1) and (A-3), preferably repeat unit (A-3)

(ii) a combination of one or more selected from the group consisting of repeat units (A-1) and (A-3), and one or more selected from the group consisting of repeat units (A-6) and (A-7), preferably a combination of repeat unit (A-3), and one or more selected from the group consisting of repeat units (A-6) and (A-7).

While a total content of repeat unit (A) is 2.5 to 95 mass % relative to all the repeat units of polymer a, 5 to 95 mass % is preferred, 20 to 95 mass % is more preferred, 30 to 95 mass % is further preferred, and 40 to 90 mass % is further preferred from the viewpoint of hydrophilizing ability, antifouling property imparting effect, and lubricity imparting effect.

When a combination of one or more selected from the group consisting of repeat units (A-1) and (A-3), and one or more selected from the group consisting of repeat units (A-6) and (A-7) is used, the ratio of contents of these is preferably 60:40 to 99.9:0.1, more preferably 75:25 to 99:1, further preferably 80:20 to 99:1, particularly preferably 85:15 to 99:1 by mass ratio, for example, from the viewpoint of transparency of the gel.

The content of repeat unit (A) can be measured by ¹H-NMR, ¹³C-NMR, for example.

### (Repeat Unit (B))

Repeat unit (B) is a repeat unit having a polyoxyalkylene group at a side chain thereof, the side chain having a terminal formed of an alkyl group having 5 to 30 carbon atoms, an alkanoyl group having 5 to 30 carbon atoms, or an aryl group, and polymer a may have one or two or more repeat units corresponding to repeat unit (B). As repeat unit (B), those other than a hydrophilic repeat unit are preferred. Among the alkyl group having 5 to 30 carbon atoms, the alkanoyl group having 5 to 30 carbon atoms, and the aryl group, the alkyl group having 5 to 30 carbon atoms, and the alkanoyl group having 5 to 30 carbon atoms are preferred.

The number of carbon atoms in the alkyl group, and the alkanoyl group is preferably 6 to 25, more preferably 7 to 20, further preferably 8 to 18, further preferably 9 to 16, particularly preferably 10 to 14 from the viewpoint of availability, for example. The alkyl group may be straight-chained or branched-chained, and concrete examples include a 2-ethylhexyl group, an octyl group, a decyl group, a lauryl group, a palmityl group, and a stearyl group. Among these, a 2-ethylhexyl group, a lauryl group, and a stearyl group are preferred, and a lauryl group and a stearyl group are more preferred. Examples of the alkanoyl group include a 2-ethylhexanoyl group, a lauroyl group, and a stearoyl group.

The number of carbon atoms in the aryl group is preferably 6 to 12. Concretely, a phenyl group can be recited. The aryl group may have an alkyl group having 1 to 30 carbon atoms as a substituent. The number of carbon atoms in the alkyl group is preferably 3 to 24, more preferably 5 to 16. The position and the number of substitution with a substituting alkyl group are arbitrary, however, a preferred number of substitution is one or two. As the aryl group having an alkyl group having 1 to 30 carbon atoms as a substituent, a nonylphenyl group can be recited.

As repeat unit (B), a repeat unit that contains a structure expressed by the following formula (9) at a side chain thereof can be recited. As a polymer species that is to be a repeat unit having the structure expressed by formula (9), those known in the art can be used, and among these, for example, (meth)acrylate-based polymer species, (meth)acrylamide-based polymer species, and styrene-based polymer species are preferred. Among these, a repeat unit expressed by the following formula (10) is preferred.

R³²OₘR³³ (9)

[In formula (9),

R³² represents an alkanediyl group having 2 to 4 carbon atoms,

R³³ represents an alkyl group having 5 to 30 carbon atoms, an alkanoyl group having 5 to 30 carbon atoms, or an aryl group, and

m represents 2 to 100 at an average value.]

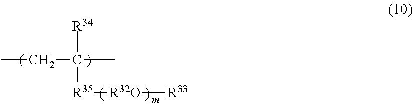

[In formula (10),

R³⁴ represents a hydrogen atom or a methyl group,

R³⁵ represents —O—, **—(C═O)—O—, **—(C═O)—NR³⁶—, **—NR³⁶—(C═O)— (R³⁶ represents a hydrogen atom or an organic group having 1 to 10 carbon atoms, ** represents a position of binding with a carbon atom to which R³⁴ in formula (10) binds) or a phenylene group, and

other signs have the same meanings as in formula (9).]

Here, each sign in formulas (9) and (10) will be described.

R³² represents an alkanediyl group having 2 to 4 carbon atoms. The number of carbon atoms in the alkanediyl group represented by R³² is preferably 2 or 3, more preferably 2.

An alkanediyl group represented by R³² may be straight-chained or branched-chained, and concrete examples include an ethane-1,2-diyl group, a propane-1,2-diyl group, a propane-1,3-diyl group, a propane-2,2-diyl group, a butane-1,2-diyl group, a butane-1,3-diyl group, and a butane-1,4-diyl group. Among these, from the viewpoint of availability, for example, an ethane-1,2-diyl group is preferred.

Here, m R³²s may be identical or different from each other.

R³³ represents an alkyl group having 5 to 30 carbon atoms, an alkanoyl group having 5 to 30 carbon atoms, or an aryl group.

The number of carbon atoms in the alkyl group, or the alkanoyl group represented by R³³ is preferably 6 to 25, more preferably 7 to 20, further preferably 8 to 18, further preferably 9 to 16, particularly preferably 10 to 14 from the viewpoint of availability, for example.

The alkyl group represented by R³³ may be straight-chained or branched-chained, and concrete examples include a 2-ethylhexyl group, an octyl group, a decyl group, a lauryl group, a palmityl group, and a stearyl group. Among these, a 2-ethylhexyl group, a lauryl group, and a stearyl group are preferred, and a lauryl group and a stearyl group are more preferred.

Examples of the alkanoyl group represented by R³³ include a 2-ethylhexanoyl group, a lauroyl group, and a stearoyl group.

The number of carbon atoms in the aryl group represented by R³³ is preferably 6 to 12. Concretely, a phenyl group can be recited.

The aryl group may have an alkyl group having 1 to 30 carbon atoms as a substituent. The number of carbon atoms in the alkyl group is preferably 3 to 24, more preferably 5 to 16. The position and the number of substitution with a substituting alkyl group are arbitrary, however, a preferred number of substitution is one or two.

As an aryl group having an alkyl group having 1 to 30 carbon atoms as a substituent, a nonylphenyl group can be recited.

Among R³³ as described above, an alkyl group having 5 to 30 carbon atoms, and an aryl group are preferred, and an alkyl group having 5 to 30 carbon atoms is more preferred from the viewpoint of availability, for example.

R³⁵ represents —O—, **—(C═O)—O—, **—(C═O)—NR³⁶—, **—NR³⁶—(C═O)— or a phenylene group. Examples of the phenylene group include a 1,2-phenylene group, a 1,3-phenylene group, and a 1,4-phenylene group.

The number of carbon atoms in the organic group represented by R³⁶ is 1 to 10, preferably 1 to 6. As the organic group, a hydrocarbon group can be recited. The hydrocarbon group is a concept involving an aliphatic hydrocarbon group, an alicyclic hydrocarbon group, and an aromatic hydrocarbon group.

The aliphatic hydrocarbon group in R³⁶ may be straight-chained or branched-chained, and concrete examples include alkyl groups such as a methyl group, an ethyl group, a n-propyl group, an isopropyl group, a n-butyl group, an isobutyl group, a sec-butyl group, a tert-butyl group, a pentyl group, a hexyl group, a heptyl group, an octyl group, a nonyl group, and a decyl group.

The alicyclic hydrocarbon group is roughly classified into a monocyclic alicyclic hydrocarbon group and a bridged cyclic hydrocarbon group. Examples of the monocyclic alicyclic hydrocarbon group include cycloalkyl groups such as a cyclopropyl group, and a cyclohexyl group. Examples of the bridged cyclic hydrocarbon group include an isobornyl group.

Examples of the aromatic hydrocarbon group include aryl groups such as a phenyl group.

Among R³⁵ as described above, **—(C═O)—O—, and a phenylene group are preferred, and **—(C═O)—O— is particularly preferred.

m represents 2 to 100 at an average value, preferably 2 to 90 at an average value, more preferably 4 to 90 at an average value, further preferably 9 to 60 at an average value, particularly preferably 10 to 40 at an average value.

Examples of the monomer from which such repeat unit (B) is derived include 2-ethylhexylpolyethylene glycol (meth)acrylate, lauroxypolyethylene glycol (meth)acrylate, stearoxypolyethylene glycol (meth)acrylate, phenoxypolyethylene glycol (meth)acrylate, phenoxypolypropylene glycol (meth)acrylate, nonylphenoxypolypropylene glycol (meth)acrylate, 2-ethylhexylpolyethylene glycol polypropylene glycol (meth)acrylate, and nonylphenoxypolyethylene glycol polypropylene glycol (meth)acrylate, and repeat unit (B) can be derived by using these singly or in combination of two or more kinds. Among these, lauroxypolyethylene glycol (meth)acrylate, and stearoxypolyethylene glycol (meth)acrylate are preferred.

While a total content of repeat unit (B) is 2.5 to 95 mass % relative to all the repeat units of polymer a, 5 to 95 mass % is preferred, 5 to 80 mass % is more preferred, 10 to 70 mass % is further preferred, and 10 to 60 mass % is further preferred from the viewpoint of hydrophilizing ability, antifouling property imparting effect, lubricity imparting effect, transparency, for example.

The content of repeat unit (B) can be measured in the same manner for measuring the content of repeat unit (A).

### (Repeat Unit (C))

Polymer a used in the present invention preferably has one or more repeat unit (C) selected from the group consisting of repeat unit (C-1) expressed by the following formula (11) and repeat unit (C-2) having a group expressed by the following formula (12) at the terminal of a side chain. By providing polymer a with such repeat unit (C), the surface hydrophilicity, the lubricity and the antifouling property of the gel are improved.

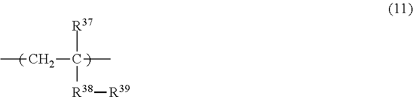

[In formula (11),

R³⁷ represents a hydrogen atom or a methyl group,

R³⁸ represents —O—, ***—(C═O)—O—, ***—(C═O)—NR⁴⁰—, ***—NR⁴⁰—(C═O)— (R⁴⁰ represents a hydrogen atom or an organic group having 1 to 10 carbon atoms, *** represents a position of binding with a carbon atom to which R³⁷ in formula (11) binds) or a phenylene group, and

R³⁹ represents a hydrocarbon group having 4 to 30 carbon atoms.]

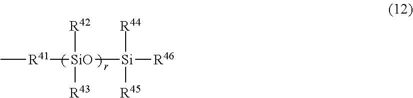

[In formula (12),

R⁴¹ represents a bivalent organic group having 1 to 10 carbon atoms,

R⁴² and R⁴³ independently represent an organic group having 1 to 10 carbon atoms,

R⁴⁴, R⁴⁵ and R⁴⁶ independently represent —OSi(R⁴⁹)₃(each of R⁴⁹ independently represents a hydrogen atom or an organic group having 1 to 8 carbon atoms) or an organic group having 1 to 10 carbon atoms, and

r represents 0 to 200 at an average value.]

### (Repeat Unit (C-1))

Repeat unit (C-1) is expressed by the above formula (11).

R³⁸ represents —O—, ***—(C═O)—O—, ***—(C═O)—NR⁴⁰—, ***—NR⁴⁰—(C═O)— or a phenylene group. Examples of the phenylene group include a 1,2-phenylene group, a 1,3-phenylene group, and a 1,4-phenylene group.

The number of carbon atoms in the organic group represented by R⁴⁰ is 1 to 10, preferably 1 to 6. As the organic group, a hydrocarbon group can be recited. The hydrocarbon group is a concept involving an aliphatic hydrocarbon group, an alicyclic hydrocarbon group, and an aromatic hydrocarbon group.

The aliphatic hydrocarbon group in R⁴⁰ may be straight-chained or branched-chained, and concrete examples include alkyl groups such as a methyl group, an ethyl group, a n-propyl group, an isopropyl group, an-butyl group, an isobutyl group, a sec-butyl group, a tert-butyl group, a pentyl group, a hexyl group, a heptyl group, an octyl group, a nonyl group, and a decyl group.

The alicyclic hydrocarbon group is roughly classified into a monocyclic alicyclic hydrocarbon group and a bridged cyclic hydrocarbon group. Examples of the monocyclic alicyclic hydrocarbon group include cycloalkyl groups such as a cyclopropyl group, and a cyclohexyl group. Examples of the bridged cyclic hydrocarbon group include an isobornyl group.

Examples of the aromatic hydrocarbon group include aryl groups such as a phenyl group.

Among R³⁸ as described above, from the viewpoint of hydrophilizing ability, antifouling property imparting effect, lubricity imparting effect, for example, ***—(C═O)—O—, ***—(C═O)—NR⁴⁰—, and a phenylene group are preferred, ***—(C═O)—O— and ***—(C═O)—NR⁴⁰— are more preferred, ***—(C═O)—O— and ***—(C═O)—NH— are further preferred, and ***—(C═O)—NH— is particularly preferred.

R³⁹ represents a hydrocarbon group having 4 to 30 carbon atoms, and may be straight-chained or branched-chained, and may contain a ring structure, however, it is preferably an alkyl group.

The number of carbon atoms in the hydrocarbon group is preferably 6 to 24, more preferably 8 to 18, further preferably 8 to 14, particularly preferably 10 to 14 from the viewpoint of hydrophilizing ability, antifouling property imparting effect, lubricity imparting effect, for example.

Examples of the alkyl group include a 2-ethylhexyl group, an octyl group, a decyl group, a lauryl group, a palmityl group, and a stearyl group. Among these, a 2-ethylhexyl group, a lauryl group, and a stearyl group are preferred, and a 2-ethylhexyl group and a lauryl group are more preferred from the viewpoint of availability, antifouling property imparting effect, for example.

Examples of the monomer from which such repeat unit (C-1) is derived include 2-ethylhexyl (meth)acrylate, lauryl (meth)acrylate, stearyl (meth)acrylate, and N-dodecyl (meth) acrylamide, and repeat unit (C-1) can be derived by using these singly or in combination of two or more kinds.

### (Repeat Unit (C-2))

As a polymer species that is to be a repeat unit having the group expressed by formula (12) at the terminal of a side chain thereof, those known in the art can be used, and among these, (meth)acrylate-based polymer species, (meth)acrylamide-based polymer species, and styrene-based polymer species are preferred. Among these, a repeat unit expressed by the following formula (13) is preferred.

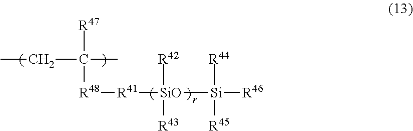

[In formula (13),

R⁴⁷ represents a hydrogen atom or a methyl group,

R⁴⁸ represents —O—, *—(C═O)—O—, *—(C═O)—NR⁰—, *—NR⁵⁰—(C═O)— (R⁵⁰ represents a hydrogen atom or an organic group having 1 to 10 carbon atoms, * represents a position of binding with a carbon atom to which R⁴⁷ in formula (13) binds) or a phenylene group, and

other signs have the same meanings as in formula (12).]

Here, each sign in formulas (12) and (13) will be described.

R⁴¹ represents a bivalent organic group having 1 to 10 carbon atoms. The number of carbon atoms in the bivalent organic group is preferably 2 to 8, more preferably 2 to 6, further preferably 2 to 4.

As the bivalent organic group, a bivalent hydrocarbon group can be recited. The bivalent hydrocarbon group is preferably a bivalent aliphatic hydrocarbon group, and may be straight-chained or branched-chained, and is more preferably an alkanediyl group. Preferred concrete examples of the alkanediyl group include an ethane-1,2-diyl group, a propane-1,2-diyl group, a propane-1,3-diyl group, a propane-2,2-diyl group, a butane-1,2-diyl group, a butane-1,3-diyl group, and a butane-1,4-diyl group.

R⁴² and R⁴³ independently represent an organic group having 1 to 10 carbon atoms. When there is a plurality of R⁴²s or R⁴³s, R⁴²s may be identical or different from each other, and R⁴³s may be identical or different from each other.

The number of carbon atoms in the organic group is preferably 1 to 6, more preferably 1 to 4, further preferably 1 or 2.

As the organic group, a hydrocarbon group can be recited. The hydrocarbon group may be straight-chained or branched-chained, and is preferably an alkyl group. Concrete examples of the alkyl group include a methyl group, an ethyl group, a n-propyl group, an isopropyl group, a n-butyl group, an isobutyl group, a sec-butyl group, and a tert-butyl group.

R⁴⁴, R⁴⁵ and R⁴⁶ independently represent —OSi(R⁴⁹)₃ or an organic group having 1 to 10 carbon atoms, and each of R⁴⁹ independently represents a hydrogen atom or an organic group having 1 to 8 carbon atoms.

The number of carbon atoms in the organic group represented by R⁴⁴, R⁴⁵ and R⁴⁶, and in the organic group represented by R⁴⁹ is preferably 1 to 6, more preferably 1 to 4, further preferably 1 or 2. The organic group represented by R⁴⁴, R⁴⁵ and R⁴⁶, and the organic group represented by R⁴⁹ can be those as recited for the organic group represented by R⁴².

In R⁴⁴, R⁴⁵ and R⁴⁶, —OSi(R⁴⁹)₃ is preferred from the viewpoint of hydrophilizing ability, and in R⁴⁹, an organic group having 1 to 8 carbon atoms is preferred from the viewpoint of hydrophilizing ability.

r represents 0 to 200 at an average value, and from the viewpoint of hydrophilizing ability, r represents preferably 0 to 100 at an average value, more preferably 0 to 50 at an average value, further preferably 0 to 25 at an average value, particularly preferably 0 to 10 at an average value.

R⁴⁸ is the same as described for R³⁸, and R⁵⁰ is the same as described for R⁴⁰.

Among these repeat units (C-1) to (C-2), from the viewpoint of hydrophilizing ability, antifouling property imparting effect and lubricity imparting effect, a repeat unit wherein R³⁸ is ***—(C═O)—NH— in repeat unit (C-1) expressed by formula (11), and a repeat unit expressed by formula (13) are preferred.

Examples of the monomer from which such repeat unit (C-2) is derived include 3-[tris(trimethylsiloxy)silyl]propyl (meth)acrylate, 3-[bis(trimethylsiloxy) (methyl) silyl]propyl (meth)acrylate, and silicone (meth)acrylate (X-22-2475 (available from Shin-Etsu Chemical Co., Ltd.), FM-0711 (available from JNC Corporation), for example), and repeat unit (C-2) can be derived by using these singly or in combination of two or more kinds.

A total content of repeat unit (C) relative to all the repeat units of polymer a is preferably 60 mass % or less, more preferably 0.1 to 50 mass %, further preferably 0.5 to 45 mass %, further preferably 0.5 to 40 mass %, further preferably 0.5 to 35 mass %, further preferably 0.5 to 30 mass %, further preferably 1 to 20 mass %, further preferably 1 to 15 mass %, further preferably 1.5 to 15 mass %, particularly preferably 1.5 to 10 mass %, from the viewpoint of hydrophilizing ability, antifouling property imparting effect, lubricity imparting effect and transparency, for example.

The content of repeat unit (C) can be measured in the same manner for measuring the content of repeat unit (A).

The mass ratio between repeat unit (A) and repeat unit (B) contained in polymer a used in the present invention [(A) (B)] is preferably 20:80 to 95:5, more preferably 30:70 to 95:5, further preferably 40:60 to 90:10, further preferably 50:50 to 90:10, particularly preferably 55:45 to 90:10 from the viewpoint of hydrophilizing ability, antifouling property imparting effect, lubricity imparting effect, transparency, for example.

When polymer a used in the present invention has repeat unit (C), the mass ratio [((A)+(B)):(C)] is preferably 60:40 to 99:1, more preferably 70:30 to 99:11, further preferably 75:25 to 99:1, further preferably 80:20 to 98.5:1.5, particularly preferably 85:15 to 98.5:1.5 from the viewpoint of hydrophilizing ability, antifouling property imparting effect, lubricity imparting effect, transparency, for example.

It is particularly preferred that the mass ratio [(A):(B)] falls within the above range of mass ratio [(A):(B)], and the mass ratio [((A)+(B)):(C)] falls within the above range of mass ratio [((A)+(B)):(C)].

It is only required that polymer a used in the present invention is a copolymer, and may be any of a block copolymer, a random copolymer and an alternating copolymer.

As polymer a, from the viewpoint of hydrophilizing ability, antifouling property imparting effect, the effect of imparting lubricity, for example, a non-network polymer is preferred, and a linear or comb-like polymer is more preferred. When polymer a has such a molecular structure, polymer a (modifying agent) becomes more likely to be held in the alternating network structure of polymer b, and the surface hydrophilicity, lubricity and antifouling property, for example are further improved. The term linear polymer used herein means a polymer having a linear molecular structure, and is a concept involving a polymer having a structure made up of a long straight-chained main chain, and a relatively short side chain that is bound to the main chain. The term comb-like polymer used herein means a polymer having a comb-like molecular structure, and refers to a polymer having a structure made up of a long straight-chained main chain, and a relatively long side chain that is bound to the main chain.

The weight average molecular weight (M_{w}) of polymer a used in the present invention is preferably 10000 to 10000000, more preferably 10000 to 5000000, further preferably 10000 to 3000000, particularly preferably 10000 to 2000000. By setting the weight average molecular weight within such a range, the handleability is improved.

The number average molecular weight (Mₙ) of polymer a used in the present invention is preferably 10000 to 10000000, more preferably 10000 to 5000000, further preferably 10000 to 3000000, further preferably 10000 to 2000000, particularly preferably 10000 to 500000.

The molecular weight distribution (M_{w}/Mₙ) is preferably 1 to 10, more preferably 1 to 7, particularly preferably 1 to 5.

The weight average molecular weight, the number average molecular weight and the molecular weight distribution can be determined according to the method described in the later-described Examples.

Polymer a used in the present invention may be soluble or insoluble in water. In the present description, “water-soluble” means that when a polymer is added to water (25° C.) so that the polymer solid is 0.5 mass %, and mixed, the solution is clear by visual observation.

The HLB (Hydrophile-Lipophile Balance) of polymer a is preferably 5 to 25, more preferably 8 to 23, particularly preferably 10 to 22.

In the present description, HLB means the value calculated from the ratio between the organic value and the inorganic value of the compound (Oda equation), and can be calculated by the calculation method described in “Formulation Design with Organic Conception Diagram” [1998, NIHON EMULSION CO., LTD].

Polymer a used in the present invention can be obtained, for example, by mixing monomers from which respective repeat units are derived, and dissolving the resultant mixture in a solvent such as water, acetonitrile, Ekuamido B-100 (available from Idemitsu Kosan Co., Ltd.), t-butyl alcohol as necessary, and adding a polymerization initiator to the solution to cause radical polymerization.

As the polymerization initiator used in conducting radical polymerization, ordinary radical polymerization initiators can be used without particular limitation, and examples of the polymerization initiator include benzoyl peroxide, lauroyl peroxide, diisopropyl peroxydicarbonate, t-butyl peroxy-2-ethylhexanoate, t-butyl peroxypivalate, t-butyl peroxydiisobutylate, azobisisobutyronitrile, azobisisodimethylvaleronitrile, persulfate, and persulfate-hydrogen sulfite system.

The loading amount of the polymerization initiator is preferably 0.001 to 10 parts by mass, more preferably 0.01 to 5 parts by mass, relative to 100 parts by mass of monomer components. The polymerization temperature is preferably 20 to 100° C., the polymerization time is preferably 0.5 to 48 hours.

The content of polymer a (modifying agent) is preferably 0.01 mass % or more, more preferably 0.1 mass % or more, further preferably 0.5 mass % or more, particularly preferably 1 mass % or more, relative to the total amount of the gel, from the viewpoint of hydrophilizing ability, antifouling property imparting effect, lubricity imparting effect, transparency, oxygen permeability, for example, and is preferably 40 mass % or less, more preferably 30 mass % or less, further preferably 20 mass % or less, particularly preferably 10 mass % or less, relative to the total amount of the gel, from the viewpoint of providing transparency and appropriate hardness.

<Polymer b>

The gel of the present invention contains polymer b. Polymer b used in the gel of the present invention is obtained through polymerization of a hydrophilic monomer (hereinafter, also referred to as hydrophilic monomer c) with a crosslinking agent (hereinafter, also referred to as crosslinking agent d).

The content of polymer b is preferably 60 mass % or more, more preferably 70 mass % or more, further preferably 80 mass % or more, particularly preferably 90 mass % or more, relative to the total amount of the gel, from the viewpoint of mechanical strength, transparency, oxygen permeability, for example, and is preferably 99.99 mass % or less, more preferably 99.9 mass % or less, further preferably 99.5 mass % or less, particularly preferably 99 mass % or less, relative to the total amount of the gel, from the viewpoint of hydrophilizing ability, antifouling property imparting effect, lubricity imparting effect, for example.

### (Hydrophilic Monomer c)

While hydrophilic monomer c is not particularly limited as long as it is a hydrophilic compound having a polymerizable functional group, a hydrophilic compound having one polymerizable functional group is preferred. As the polymerizable functional group, a polymerizable unsaturated bond is preferred.

Concrete examples of hydrophilic monomer c include carboxylic acids having a polymerizable functional group such as (meth)acrylic acid, itaconic acid, crotonic acid, and vinylbenzoic acid; (meth)acrylates having a hydroxyl group such as hydroxymethyl (meth)acrylate, 2-hydroxyethyl (meth)acrylate, 2-hydroxypropyl (meth)acrylate, 2,3-dihydroxypropyl (meth)acrylate, polyethylene glycol mono(meth)acrylate, and polypropylene glycol mono(meth)acrylate; (meth)acrylamides such as (meth)acrylamide, N-methyl(meth)acrylamide, N-ethyl(meth)acrylamide, N-hydroxyethyl(meth)acrylamide, N,N-dimethyl(meth)acrylamide, N,N-diethyl(meth)acrylamide, and N-ethyl-N-aminoethyl(meth)acrylamide; (alkyl)aminoalkyl (meth)acrylates such as 2-dimethylaminoethyl (meth)acrylate, and 2-butylaminoethyl (meth)acrylate; pyrrolidones having a polymerizable functional group such as N-vinyl-3-methyl-2-pyrrolidone, N-vinyl-4-methyl-2-pyrrolidone, N-vinyl-5-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-(meth)acrylonitrilepyrrolidone, N-(meth)acryloyloxyethylpyrrolidone, 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-i-propyl-3-methylene-2-pyrrolidone, 1-i-propyl-5-methylene-2-pyrrolidone, 1-n-butyl-3-methylene-2-pyrrolidone, and 1-t-butyl-3-methylene-2-pyrrolidone; N-vinylpiperidones such as N-vinyl-2-piperidone, N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, and N-vinyl-4,4-dimethyl-2-piperidone; N-vinyllactams such as N-vinyl-2-caprolactam, N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, and N-vinyl-3,5,7-trimethyl-2-caprolactam; N-vinylamides such as N-vinylformamide, N-vinyl-N-methylformamide, N-vinyl-N-ethylformamide, N-vinylacetamide, N-vinyl-N-methylacetamide, and N-vinyl-N-ethylacetamide; and other hydrophilic monomers such as aminostyrene, hydroxystyrene, vinyl acetate, glycidyl (meth)acrylate, allylglycidyl ether, vinyl propionate, N-vinylimidazole, N-vinylpiperidine, N-vinylsuccinimide, N-vinylphthalimide, N-(meth)acryloylpiperidine, and N-(meth)acryloylmorpholine.

These hydrophilic monomers can be used singly or in combination of two or more kinds.

Among these hydrophilic monomers, (meth)acrylates, and (meth)acrylamides having a hydroxyl group are preferred from the viewpoint of hydrophilizing ability, antifouling property imparting effect, lubricity imparting effect, mechanical properties and storage stability of the gel or lens.

Pyrrolidone derivatives having a methylene group as the polymerizable group, and (meth)acrylamides substituted with nitrogen can impart a desired effect of the present invention to gel or lens, and are highly compatible with silicone compound g as will be described later. Since vinyl acetate is hydrolyzed by acid or base, when such a hydrophilic monomer is used, further flexibility and surface hydrophilicity can be imparted to gel or lens by treating gel or lens with acid or base after production.

### (Crosslinking Agent d)

It is only required that crosslinking agent d has two or more polymerizable functional groups. As the polymerizable functional group, a polymerizable unsaturated bond is preferred.

Concrete examples of crosslinking agent d include crosslinking agents having two polymerizable functional groups such as allyl (meth)acrylate, vinyl (meth)acrylate, 4-vinylbenzyl (meth)acrylate, 3-vinylbenzyl (meth)acrylate, (meth)acryloyloxyethyl (meth)acrylate, ethylene glycol di(meth)acrylate, diethylene glycol di(meth)acrylate, diethylene glycol diallylether, triethylene glycol di(meth)acrylate, tetraethylene glycol di(meth)acrylate, propylene glycol di(meth)acrylate, dipropylene glycol di(meth)acrylate, butane diol (meth)acrylate, 2,2-bis(p-(meth)acryloyloxyphenyl)hexafluoropropane, 2,2-bis(m-(meth)acryloyloxyphenyl)hexafluoropropane, 2,2-bis(o-(meth)acryloyloxyphenyl)hexafluoropropane, 2,2-bis(p-(meth)acryloyloxyphenyl)propane, 2,2-bis(m-(meth)acryloyloxyphenyl)propane, 2,2-bis(o-(meth)acryloyloxyphenyl)propane, 1,4-bis(2-(meth)acryloyloxyhexafluoroisopropyl)benzene, 1,3-bis(2-(meth)acryloyloxyhexafluoroisopropyl)benzene, 1,2-bis(2-(meth)acryloyloxyhexafluoroisopropyl)benzene, 1,4-bis(2-(meth)acryloyloxyisopropyl)benzene, 1,3-bis(2-(meth)acryloyloxyisopropyl)benzene, 1,2-bis(2-(meth)acryloyloxyisopropyl)benzene; and crosslinking agents having three polymerizable functional groups such as trimethylol propane tri(meth)acrylate.

These crosslinking agents can be used singly or in combination of two or more kinds.

The use amount of crosslinking agent d in obtaining polymer b is preferably 0.1 to 20 parts by mass, more preferably 5 to 15 parts by mass, relative to 100 parts by mass of hydrophilic monomer c.

Polymer b can be synthesized through polymerization of hydrophilic monomer c with crosslinking agent d. Such polymerization can be conducted by appropriately combining ordinary methods, and preferably conducted in the presence of polymer a. By synthesizing polymer b in this manner, such a condition that polymer a (modifying agent) is held in the alternating network structure of polymer b arises in gel, and gel with improved surface hydrophilicity, lubricity and antifouling property is prepared.

### (Silicone Compound e Having Polymerizable Functional Group)

Polymer b is preferably obtained through polymerization of a silicone compound having a polymerizable functional group (hereinafter, also referred to as silicone compound e having a polymerizable functional group) with hydrophilic monomer c and crosslinking agent d. This imparts high oxygen permeability and flexibility to the obtained gel or lens. As a polymerizable functional group in silicone compound e having a polymerizable functional group, a polymerizable unsaturated bond is preferred.

Examples of silicone compound e having a polymerizable functional group include a silicone-containing alkyl (meth)acrylate compound, a silicone-containing styrene compound, a silicone-containing fumarate diester compound, and a compound having an ethylenic unsaturated group and a silicone structure via a urethane bond. These can be used singly or in combination of two or more kinds.

Examples of the silicone-containing alkyl (meth)acrylate compound include trimethylsiloxy dimethylsilylmethyl (meth)acrylate, trimethylsiloxy dimethylsilylpropyl (meth)acrylate, methylbis(trimethylsiloxy)silylpropyl (meth)acrylate, tris(trimethylsiloxy)silylpropyl (meth)acrylate, mono[methylbis(trimethylsiloxy)siloxy]bis(trimethylsiloxy)silylpropyl (meth)acrylate, tris[methylbis(trimethylsiloxy)siloxy]silylpropyl (meth)acrylate, methylbis(trimethylsiloxy)silylpropylglyceryl (meth)acrylate, tris(trimethylsiloxy)silylpropylglyceryl (meth)acrylate, mono[methylbis(trimethylsiloxy)siloxy]bis(trimethylsiloxy)silylpropylglyceryl (meth)acrylate, trimethylsilylethyl tetramethyldisiloxypropylglyceryl (meth)acrylate, trimethylsilylmethyl (meth)acrylate, trimethylsilylpropyl (meth)acrylate, trimethylsilylpropylglyceryl (meth)acrylate, trimethylsiloxydimethylsilylpropylglyceryl (meth)acrylate, methylbis(trimethylsiloxy)silylethyltetramethyldisiloxymethyl (meth)acrylate, tetramethyltriisopropylcyclotetrasiloxanylpropyl (meth)acrylate, and tetramethyltriisopropylcyclotetrasiloxybis(trimethylsiloxy) silylpropyl (meth)acrylate.

Examples of the silicone-containing styrene compound include a compound expressed by the following formula (14).

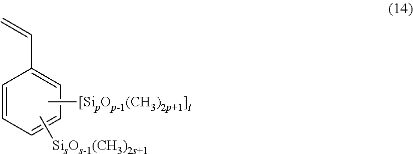

[In formula (14),

p and s independently represent an integer of 1 to 15, and

t represents 0 or 1.]

Concrete examples of the silicone-containing styrene compound include tris(trimethylsiloxy)silylstyrene, bis(trimethylsiloxy)methylsilylstyrene, (trimethylsiloxy)dimethylsilylstyrene, tris(trimethylsiloxy)siloxydimethylsilylstyrene, [bis(trimethylsiloxy)methylsiloxy]dimethylsilylstyrene, (trimethylsiloxy)dimethylsilylstyrene, heptamethyltrisiloxanylstyrene, nonamethyltetrasiloxanylstyrene, pentadecamethylheptasiloxanylstyrene, heneicosamethyldecasiloxanylstyrene, heptacosamethyltridecasiloxanylstyrene, hentriacontamethylpentadecasiloxanylstyrene, trimethylsiloxypentamethyldisiloxymethylsilylstyrene, tris(pentamethyldisiloxy)silylstyrene, tris(trimethylsiloxy)siloxybis(trimethylsiloxy)silylstyrene, bis(heptamethyltrisiloxy)methylsilylstyrene, tris[methylbis(trimethylsiloxy)siloxy]silylstyrene, trimethylsiloxybis[tris(trimethylsiloxy)siloxy]silylstyrene, heptakis(trimethylsiloxy)trisilylstyrene, nonamethyltetrasiloxyundecylmethylpentasiloxymethylsilylstyrene, tris[tris(trimethylsiloxy)siloxy]silylstyrene, (tristrimethylsiloxyhexamethyl)tetrasiloxy[tris(trimethylsiloxy)siloxy]trimethylsiloxysilylstyrene, nonakis(trimethylsiloxy)tetrasilylstyrene, bis(tridecamethylhexasiloxy)methylsilylstyrene, heptamethylcyclotetrasiloxanylstyrene, heptamethylcyclotetrasiloxybis(trimethylsiloxy)silylstyrene, tripropyltetramethylcyclotetrasiloxanylstyrene, and trimethylsilylstyrene.

Examples of the silicone-containing fumarate diester compound include a compound expressed by the following formula (15).

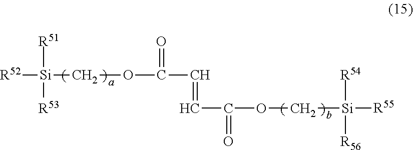

[In formula (15),

R⁵¹ to R⁵⁶ independently represent a methyl group or a trimethylsiloxy group, and

a and b independently represent an integer of 1 to 10.]

Concrete examples of the silicone-containing fumarate diester compound include bis(3-(trimethylsilyl)propyl)fumarate, bis(3-(pentamethyldisiloxanyl)propyl)fumarate, and bis(tris(trimethylsiloxy)silylpropyl)fumarate.

Examples of the compound having an ethylenic unsaturated group and a silicone structure via a urethane bond include a polysiloxane macro monomer expressed by the following formula (16).

The compound having an ethylenic unsaturated group and a silicone structure via a urethane bond imparts flexibility, flexible repellency, and oxygen permeability to the obtained gel or lens by having a urethane bond and a siloxane moiety, and also has the function of improving the mechanical strength. In other words, such a silicone compound has an ethylenic unsaturated group which is a polymerizable functional group at both terminals of the molecule, and is copolymerized with other copolymerizable component via this polymerizable functional group. Therefore, not only the mechanical strengthening by the crosslinking of the obtained molecule, but also the reinforcing effect by the chemical bonding can be imparted to the gel or lens.

A¹-U¹—(S¹-U²)ⱼ-S²-U³-A² (16)

[In formula (16),

A¹ represents a group expressed by the following formula (17),

A² represents a group expressed by the following formula (18),

U¹ represents a group expressed by the following formula (19),

S¹ and S² independently represent a group expressed by the following formula (20),

U² represents a group expressed by the following formula (21),

U³ represents a group expressed by the following formula (22), and

j represents an integer of 0 to 10.]

Y²¹—Z²¹—R⁵⁷— (17)

[In formula (17),

Y²¹ represents a (meth)acryloyl group, vinyl group or an allyl group,

Z²¹ represents a single bond or an oxygen atom, and

R⁵⁷ represents a single bond, or a bivalent hydrocarbon group having 1 to 12 carbon atoms.]

—R⁵⁸—Z²²—Y²² (18)

[In formula (18),

Y²² represents a (meth)acryloyl group, a vinyl group or an allyl group,

Z²² represents a single bond or an oxygen atom, and

R⁵⁸ represents a single bond, or a bivalent hydrocarbon group having 1 to 12 carbon atoms.]

—X²¹-E²¹-X²⁵—R⁵⁹— (19)

[In formula (19),

X²¹ and X²⁵ independently represent a single bond, an oxygen atom, an alkylene glycol group or a polyalkylene glycol group,

E²¹ represents —(NH)—(C═O)— (provided that in this case, X²¹ is a single bond, and X²⁵ is an oxygen atom, an alkylene glycol group or a polyalkylene glycol group. In other words, in this case, E²¹ forms a urethane bond with X²⁵. ), —(C═O)—(NH)— (provided that in this case, X²¹ is an oxygen atom, an alkylene glycol group or a polyalkylene glycol group, and X²⁵ is a single bond. That is, in this case, E²¹ forms a urethane bond with X²¹.), or a bivalent group derived from diisocyanate (provided that in this case, X²¹ and X²⁵ independently represent an oxygen atom, an alkylene glycol group or a polyalkylene glycol group. That is, in this case, E²¹ forms two urethane bonds with X²¹ and X²⁵.), and

R⁵⁹ represents a straight-chain or branched-chain alkanediyl group having 1 to 6 carbon atoms.]

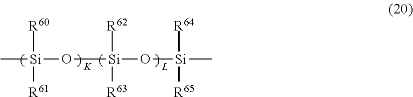

[In formula (20),

R⁶⁰ to R⁶⁵ independently represent a hydrogen atom, an alkyl group having 1 to 6 carbon atoms, an alkyl fluoride group, or a phenyl group,

K represents an integer of 10 to 100, and

L represents an integer of 0 to 90, provided that K+L is an integer of 10 to 100.]

—R⁶⁶—X²⁷-E²⁴-X²⁸—R⁶⁷— (21)

[In formula (21),

R⁶⁶ and R⁶⁷ independently represent a straight-chain or branched-chain alkanediyl group having 1 to 6 carbon atoms,

X²⁷ and X²⁸ independently represent an oxygen atom, an alkylene glycol group or a polyalkylene glycol group,

E²⁴ represents a bivalent group derived from diisocyanate. E²⁴ forms two urethane bonds with X²⁷ and X²⁸.]

—R⁶⁸—X²⁶-E²²-X²²— (22)

[In formula (22),

R⁶⁸ represents a straight-chain or branched-chain alkanediyl group having 1 to 6 carbon atoms,

X²² and X²⁶ independently represent a single bond, an oxygen atom, an alkylene glycol group or a polyalkylene glycol group, and

E²² represents —(NH)—(C═O)— (provided that in this case, X²² is an oxygen atom, an alkylene glycol group or a polyalkylene glycol group, and X²⁶ is a single bond. That is, in this case, E²² forms a urethane bond with X²².), —(C═O)—(NH)— (provided that in this case, X²² is a single bond, and X²⁶ is an oxygen atom, an alkylene glycol group or a polyalkylene glycol group. That is, in this case, E²² forms a urethane bond with X²⁶.), or a bivalent group derived from diisocyanate (provided that in this case, X²² and X²⁶ independently represent an oxygen atom, an alkylene glycol group or a polyalkylene glycol group. That is, in this case, E²² forms two urethane bonds with X²² and X²⁶.).]

Here, each sign in formulas (16) to (22) will be described.

In formula (16), j represents an integer of 0 to 10, and preferably represents an integer of 0 to 5 from the viewpoint of improving the compatibility with hydrophilic monomer c and achieving excellent transparency.

Y²¹ in formula (17), and Y²² in formula (18) independently represent a (meth)acryloyl group, a vinyl group or an allyl group, and from the viewpoint of easily copolymerizing with hydrophilic monomer c, a (meth)acryloyl group is preferred.

Z²¹ in formula (17) and Z²² in formula (18) independently represent a single bond or an oxygen atom, preferably an oxygen atom.

R⁵⁷ in formula (17) and R⁵⁸ in formula (18) independently represent a single bond, or a bivalent hydrocarbon group having 1 to 12 carbon atoms, and is preferably a bivalent hydrocarbon group having 1 to 12 carbon atoms. Such a bivalent hydrocarbon group can be straight-chained or branched-chained, and may have an aromatic ring, but is preferably a bivalent aliphatic hydrocarbon group, more preferably an alkanediyl group. The number of carbon atoms in the bivalent hydrocarbon group is preferably 2 to 4. Concrete examples include an ethane-1,2-diyl group, a propane-1,1-diyl group, a propane-1,2-diyl group, a propane-1,3-diyl group, a propane-2,2-diyl group, and a butane-1,4-diyl group.

E²¹ in formula (19) and E²² in formula (22) independently represent —(NH)—(C═O)—, —(C═O)—(NH)—, or a bivalent group derived from diisocyanate, and preferably represents a bivalent group derived from diisocyanate.

E²⁴ in formula (21) represents a bivalent group derived from diisocyanate. E²⁴ forms two urethane bonds with X²⁷ and X²⁸

The diisocyanate from which “a bivalent group derived from diisocyanate” in E²¹, E²² and E²⁴ is derived may be a saturated or unsaturated aliphatic diisocyanate, or may be an alicyclic or aromatic diisocyanate.

Concrete examples of the bivalent group derived from diisocyanate include bivalent groups derived from saturated aliphatic diisocyanate such as ethylene diisocyanate, 1,3-diiscoyanate propane, and hexamethylene diisocyanate; bivalent groups derived from alicyclic diisocyanate such as 1,2-diisocyanate cyclohexane, bis(4-isocyanate cyclohexyl)methane, and isophorone diisocyanate; bivalent groups derived from aromatic diisocyanate such as tolylene diisocyanate, and 1,5-diisocyanate naphthalene; and bivalent groups derived from unsaturated aliphatic diisocyanate such as 2,2′-diisocyanate diethyl fumarate.

Among these, from the viewpoint of availability and impartment of strength to the gel or lens, a bivalent group derived from hexamethylene diisocyanate, a bivalent group derived from tolylene diisocyanate, and a bivalent group derived from isophorone diisocyanate are preferred.

X²¹ and X²⁵ in formula (19), and X²² and X²⁶ in formula (22) independently represent a single bond, an oxygen atom, an alkylene glycol group or a polyalkylene glycol group.

When E²¹ is —(NH)—(C═O)—, X²¹ is a single bond, and X²⁵ is an oxygen atom, an alkylene glycol group or a polyalkylene glycol group. That is, in this case, E²¹ and X²⁵ form a urethane bond. When E²¹ is —(C═O)—(NH)—, X²¹ is an oxygen atom, an alkylene glycol group or a polyalkylene glycol group, and X²⁵ is a single bond. That is, in this case, E²¹ and X²¹ form a urethane bond. When E²¹ is a bivalent group derived from diisocyanate, X²¹ and X²⁵ independently represent an oxygen atom, an alkylene glycol group or a polyalkylene glycol group. That is, in this case, E²¹ forms two urethane bonds with X²¹ and X²⁵

When E²² is —(NH)—(C═O)—, X²² is an oxygen atom, an alkylene glycol group or a polyalkylene glycol group, and X²⁶ is a single bond. That is, in this case, E²² forms a urethane bond with X²². When E²² is —(C═O)—(NH)—, X²² is a single bond, and X²⁶ is an oxygen atom, an alkylene glycol group or a polyalkylene glycol group. That is, in this case, E²² forms a urethane bond with X²⁶. When E²² is a bivalent group derived from diisocyanate, X²² and X²⁶ independently represent an oxygen atom, an alkylene glycol group or a polyalkylene glycol group. That is, in this case, E²² forms two urethane bonds with X²² and X²⁶

As X²¹ and X²⁵ in formula (19), and X²² and X²⁶ in formula (22), an oxygen atom, an alkylene glycol group, and a polyalkylene glycol group are preferred.

X²⁷ and X²⁸ in formula (21) independently represent an oxygen atom, an alkylene glycol group or a polyalkylene glycol group.

The number of carbon atoms in the alkylene glycol group, or the polyalkylene glycol group represented by X²¹, X²², X²⁵, X²⁶, X²⁷, and X²⁸ is preferably 1 to 20, more preferably 1 to 6. As the alkylene glycol group, or the polyalkylene glycol group, those expressed by the following formula (23) are preferred.

—O—(CₓH₂ₓ—O)_{y}— (23)

[In formula (23), x represents an integer of 1 to 4, and y represents an integer of 1 to 5.]

R⁵⁹ in formula (19), R⁶⁶ and R⁶⁷ in formula (21), and R⁶⁸ in formula (22) represent a straight-chain or branched-chain alkanediyl group having 1 to 6 carbon atoms. Concrete examples include a methane-1,1-diyl group, an ethane-1,2-diyl group, a propane-1,1-diyl group, a propane-1,2-diyl group, a propane-1,3-diyl group, a propane-2,2-diyl group, a butane-1,4-diyl group, a pentane-1,5-diyl group, and a hexane-1,6-diyl group.

R⁶⁰ to R⁶⁵ in formula (20) independently represent a hydrogen atom, an alkyl group having 1 to 6 carbon atoms, an alkyl fluoride group, or a phenyl group, and an alkyl group having 1 to 6 carbon atoms, and an alkyl fluoride group are preferred.

The number of carbon atoms in the alkyl group represented by R⁶⁰ to R⁶⁵ is preferably 1 to 3, more preferably 1 or 2, further preferably 1. The alkyl group represented by R⁶⁰ to R⁶⁵ may be straight-chained or branched-chained, and concrete examples include a methyl group, an ethyl group, a n-propyl group, an isopropyl group, a n-butyl group, an isobutyl group, a sec-butyl group, and a tert-butyl group.

As the alkyl fluoride group represented by R⁶⁰ to R⁶⁵, a group expressed by —(CH₂)α-CβF₂β₊₁(α and β independently represent an integer of 1 to 10.) is preferred.

Concrete examples of the alkyl fluoride group include straight chain alkyl fluoride groups such as a 3,3,3-trifluoro-n-propyl group, a 2-(perfluorobutyl)ethyl group, and a 2-(perfluorooctyl)ethyl group, and branched-chain alkyl fluoride groups such as a 2-(perfluoro-5-methylhexyl)ethyl group.

When at least one of R⁶⁰ to R⁶⁵ is an alkyl fluoride group, the lipid antifouling property of the gel or lens is improved.

In formula (20), K represents an integer of 10 to 100, L represents an integer of 0 to 90, and K+L is an integer of 10 to 100. Since K+L is an integer of 10 to 100, the compatibility with hydrophilic monomer c is improved, and the transparency is improved. Also, oxygen permeability and flexibility of the gel or lens are improved. As K+L, an integer of 10 to 80 is preferred.

Representative examples of the polysiloxane macromonomer expressed by formula (16) include compounds expressed by the following formula (24) or (25).

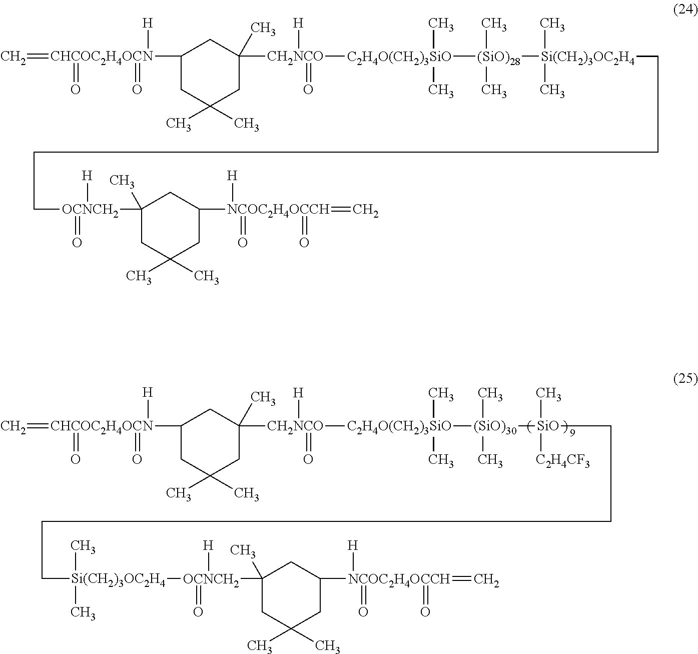

When silicone compound e having a polymerizable functional group is used in obtaining polymer b, the use amount is preferably 50 to 150 parts by mass, more preferably 100 to 130 parts by mass relative to 100 parts by mass of hydrophilic monomer c.

### (Property Regulating Compound f Having Polymerizable Functional Group)

Polymer b can be obtained through copolymerization of hydrophilic monomer c, crosslinking agent d, and silicone compound e having a polymerizable functional group, as well as a property regulating compound having a polymerizable functional group (hereinafter, also referred to as property regulating compound f having a polymerizable functional group).

Examples of the property regulating compound having a polymerizable functional group include alkyl (meth)acrylate, fluorine-containing alkyl (meth)acrylate, a hardness regulating monomer, a polymerizable ultraviolet absorber, a polymerizable pigment, and a polymerizable ultraviolet absorbing pigment.

When alkyl (meth)acrylate is used, hardness and softness can be imparted by regulating the hardness of the ophthalmic lens.

Examples of the alkyl (meth)acrylate include straight-chain, branched-chain or cyclic alkyl (meth)acrylates such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, pentyl (meth)acrylate, t-pentyl(meth)acrylate, hexyl (meth)acrylate, heptyl (meth)acrylate, n-octyl (meth)acrylate, 2-ethylhexyl (meth)acrylate, nonyl (meth)acrylate, n-decyl (meth)acrylate, n-dodecyl (meth)acrylate, stearyl (meth)acrylate, cyclopentyl (meth)acrylate, and cyclohexyl (meth)acrylate.

These alkyl (meth)acrylates can be used singly or in combination of two or more kinds.

When a fluorine-containing alkyl (meth)acrylate is used, the lipid antifouling property of the ophthalmic lens can be improved.

Examples of the fluorine-containing alkyl (meth)acrylate include a compound expressed by the following formula (29).

CH₂=CR⁸¹COOCᵥH_{(2v-w+1)}F_{w} (29)

[In formula (29),

R⁸¹ represents a hydrogen atom or a methyl group,

v represents an integer of 1 to 15, and

w represents an integer of 1 to (2v+1).]

Concrete examples of the fluorine-containing alkyl (meth)acrylate include 2,2,2-trifluoroethyl (meth)acrylate, 2,2,3,3-tetrafluoropropyl (meth)acrylate, 2,2,3,3-tetrafluoro-t-pentyl (meth)acrylate, 2,2,3,4,4,4-hexafluorobutyl (meth)acrylate, 2,2,3,4,4,4-hexafluoro-t-hexyl (meth)acrylate, 2,3,4,5,5,5-hexafluoro-2,4-bis(trifluoromethyl)pentyl (meth)acrylate, 2,2,3,3,4,4-hexafluorobutyl (meth)acrylate, 2,2,2,2′,2′,2′-hexafluoroisopropyl (meth)acrylate, 2,2,3,3,4,4,4-heptafluorobutyl (meth)acrylate, 2,2,3,3,4,4,5,5-octafluoropentyl (meth)acrylate, 2,2,3,3,4,4,5,5,5-nonafluoropentyl (meth)acrylate, 2,2,3,3,4,4,5,5,6,6,7,7-dodecafluoroheptyl (meth)acrylate, 3,3,4,4,5,5,6,6,7,7,8,8-dodecafluorooctyl (meth)acrylate, 3,3,4,4,5,5,6,6,7,7,8,8,8-tridecafluorooctyl (meth)acrylate, 2,2,3,3,4,4,5,5,6,6,7,7,7-tridecafluoroheptyl (meth)acrylate, 3,3,4,4,5,5,6,6,7,7,8,8,9,9,10,10-hexadecafluorodecyl (meth)acrylate, 3,3,4,4,5,5,6,6,7,7,8,8,9,9,10,10,10-heptadecafluorodecyl (meth)acrylate, 3,3,4,4,5,5,6,6,7,7,8,8,9,9,10,10,11,11-octadecafluoroundecyl (meth)acrylate, 3,3,4,4,5,5,6,6,7,7,8,8,9,9,10,10,11,11,11-nonadecafluoroundecyl (meth)acrylate, and 3,3,4,4,5,5,6,6,7,7,8,8,9,9,10,10,11,11,12,12-eicosafluorododecyl (meth)acrylate.

These fluorine-containing alkyl (meth)acrylates can be used singly or in combination of two or more kinds.

When a hardness regulating monomer is used, hardness and softness can be imparted by regulating the hardness of the ophthalmic lens.

Examples of the hardness regulating monomer include alkoxyalkyl (meth)acrylates such as 2-ethoxyethyl (meth)acrylate, 3-ethoxypropyl (meth)acrylate, 2-methoxyethyl (meth)acrylate, and 3-methoxypropyl (meth)acrylate; alkylthioalkyl (meth)acrylates such as ethylthioethyl (meth)acrylate, and methylthioethyl (meth)acrylate; and styrenes such as styrene, α-methylstyrene, methylstyrene, ethylstyrene, propylstyrene, butylstyrene, t-butylstyrene, isobutylstyrene, pentylstyrene, methyl-α-methylstyrene, ethyl-α-methylstyrene, propyl-α-methylstyrene, butyl-α-methylstyrene, t-butyl-α-methylstyrene, isobutyl-α-methylstyrene, and pentyl-α-methylstyrene. These hardness regulating monomers can be used singly or in combination of two or more kinds.

When a polymerizable ultraviolet absorber, a polymerizable pigment, and a polymerizable ultraviolet absorbing pigment are used, it is possible to impart ultraviolet absorptivity to the ophthalmic lens and to color the ophthalmic lens.

Examples of the polymerizable ultraviolet absorber include benzophenone-based polymerizable ultraviolet absorbers such as 2-hydroxy-4-(meth)acryloyloxybenzophenone, 2-hydroxy-4-(meth)acryloyloxy-5-t-butylbenzophenone, 2-hydroxy-4-(meth)acryloyloxy-2′,4′-dichlorobenzophenone, and 2-hydroxy-4-(2′-hydroxy-3′-(meth)acryloyloxypropoxy)benzophenone; benzotriazole-based polymerizable ultraviolet absorbers such as 2-(2′-hydroxy-5′-(meth)acryloyloxyethylphenyl)-2H-benzotriazole, 2-(2′-hydroxy-5′-(meth)acryloyloxyethylphenyl)-5-chloro-2H-benzotriazole, 2-[3-(2H-benzotriazole-2-yl)-4-hydroxyphenyl]ethyl (meth)acrylate, 2-(2′-hydroxy-5′-(meth)acryloyloxypropylphenyl)-2H-benzotriazole, 2-(2′-hydroxy-5′-(meth)acryloyloxypropyl-3′-t-butylphenyl)-5-chloro-2H-benzotriazole, 2-(2′-hydroxy-5′-(2″-(meth)acryloyloxyethoxy)-3′-t-butylphenyl)-5-methyl-2H-benzotriazole, and 2-[2′-hydroxy-5′-(2-(meth)acryloyloxyethyl)phenyl]-2H-benzotriazole; salicylic acid derivative-based polymerizable ultraviolet absorbers such as phenyl 2-hydroxy-4-(meth)acryloyloxymethylbenzoate; and other polymerizable ultraviolet absorbers such as 2-cyano-3-phenyl-3-(3′-(meth)acryloyloxyphenyl)propenyl acid methyl ester.

These polymerizable ultraviolet absorbers can be used singly or in combination of two or more kinds.

Examples of the polymerizable pigment include azo-based polymerizable pigments such as 1-phenylazo-4-(meth)acryloyloxynaphthalene, 1-phenylazo-2-hydroxy-3-(meth)acryloyloxynaphthalene, 1-naphthylazo-2-hydroxy-3-(meth)acryloyloxynaphthalene, 1-(α-anthryl azo)-2-hydroxy-3-(meth)acryloyloxynaphthalene, 1-((4′-(phenylazo)-phenyl)azo)-2-hydroxy-3-(meth)acryloyloxynaphthalene, 1-(2′,4′-xylylazo)-2-(meth)acryloyloxynaphthalene, 1-(o-tolyl azo)-2-(meth)acryloyloxynaphthalene, 2-(m-(meth)acryloylamide-anilino)-4,6-bis(1′-(o-tolylazo)-2′-naphthylamino)-1,3,5-triazine, 2-(m-vinylanilino)-4-(4′-nitrophenylazoanilino)-6-chloro-1,3,5-triazine, 2-(1′-(o-tolyl azo)-2′-naphthyloxy)-4-(m-vinylanilino)-6-chloro-1,3,5-triazine, 2-(p-vinylanilino)-4-(1′-(o-tolyl azo)-2′naphthylamino)-6-chloro-1,3,5-triazine, N-(1′-(o-tolyl azo)-2′-naphthyl)-3-vinylphthalic monoamide, N-(1′-(o-tolyl azo)-2′-naphthyl)-6-vinylphthalic monoamide, 3-vinylphthalic acid-(4′-(p-sulfophenylazo)-1′-naphthyl)monoester, 6-vinylphthalic acid-(4′-(p-sulfophenylazo)-1′-naphthyl)monoester, 3-(meth)acryloylamide-4-phenylazophenol, 3-(meth)acryloylamide-4-(8′-hydroxy-3′,6′-disulfo-1′-naphthylazo)-phenol, 3-(meth)acryloylamide-4-(1′-phenylazo-2′-naphthylazo)-phenol, 3-(meth)acryloylamide-4-(p-tolyl azo)phenol, 2-amino-4-(m-(2′-hydroxy-1′-naphthylazo)anilino)-6-isopropenyl-1,3,5-triazine, 2-amino-4-(N-methyl-p-(2′-hydroxy-1′-naphthylazo)anilino)-6-isopropenyl-1,3,5-triazine, 2-amino-4-(m-(4′-hydroxy-1′-phenylazo)anilino)-6-isopropenyl-1,3,5-triazine, 2-amino-4-(N-methyl-p-(4′-hydroxyphenylazo)anilino)-6-isopropenyl-1,3,5-triazine, 2-amino-4-(m-(3′-methyl-1′-phenyl-5′-hydroxy-4′-pyrazoylazo)anilino)-6-isopropenyl-1,3,5-triazine, 2-amino-4-(N-methyl-p-(3′-methyl-1′-phenyl-5′-hydroxy-4′-pyrazolyl azo)anilino)-6-isopropenyl-1,3,5-triazine, 2-amino-4-(p-phenylazoanilino)-6-isopropenyl-1,3,5-triazine and 4-phenylazo-7-(meth)acryloylamide-1-naphthol; and

anthraquinone-based polymerizable pigments such as 1,5-bis((meth)acryloylamino)-9,10-anthraquinone, 1-(4′-vinylbenzoyl amide)-9,10-anthraquinone, 4-amino-1-(4′-vinylbenzoyl amide)-9,10-anthraquinone, 5-amino-1-(4′-vinylbenzoyl amide)-9,10-anthraquinone, 8-amino-1-(4′-vinylbenzoylamide)-9,10-anthraquinone, 4-nitro-1-(4′-vinylbenzoylamide)-9,10-anthraquinone, 4-hydroxy-1-(4′-vinylbenzoylamide)-9,10-anthraquinone, 1-(3′-vinylbenzoylamide)-9,10-anthraquinone, 1-(2′-vinylbenzoylamide)-9,10-anthraquinone, 1-(4′-isopropenylbenzoylamide)-9,10-anthraquinone, 1-(3′-isopropenylbenzoylamide)-9,10-anthraquinone, 1-(2′-isopropenylbenzoylamide)-9,10-anthraquinone, 1,4-bis(4′-vinylbenzoylamide)-9,10-anthraquinone, 1,4-bis(4′-isopropenylbenzoylamide)-9,10-anthraquinone, 1,5′-bis(4′-vinylbenzoylamide)-9,10-anthraquinone, 1,5-bis(4′-isopropenylbenzoylamide)-9,10-anthraquinone, 1-methylamino-4-(3′-vinylbenzoylamide)-9,10-anthraquinone, 1-methylamino-4-(4′-vinylbenzoyloxyethylamino)-9,10-anthraquinone, 1-amino-4-(3′-vinylphenylamino)-9,10-anthraquinone-2-sulfonic acid, 1-amino-4-(4′-vinylphenylamino)-9,10-anthraquinone-2-sulfonic acid, 1-amino-4-(2′-vinylbenzylamino)-9,10-anthraquinone-2-sulfonic acid, 1-amino-4-(3′-(meth)acryloylaminophenylamino)-9,10-anthraquinone-2-sulfonic acid, 1-amino-4-(3′-(meth)acryloylaminobenzylamino)-9,10-anthraquinone-2-sulfonic acid, 1-(β-ethoxycarbonylallylamino)-9,10-anthraquinone, 1-(β-carboxyallylamino)-9,10-anthraquinone, 1,5-di-(β-carboxyallylamino)-9,10-anthraquinone, 1-(β-isopropoxycarbonylallylamino)-5-benzoylamide-9,10-anthraquinone, 2-(3′-(meth)acryloylamide-anilino)-4-(3′-(3″-sulfo-4″-amino anthraquinone-1″-yl)-amino-anilino)-6-chloro-1,3,5-triazine, 2-(3′-(meth)acryloylamide-anilino)-4-(3′-(3″-sulfo-4″-amino anthraquinone-1″-yl)-amino-anilino)-6-hydrazino-1,3,5-triazine, 2,4-bis-((4″-methoxyanthraquinone-1″-yl)-amino)-6-(3′-vinyl anilino)-1,3,5-triazine, and 2-(2′-vinylphenoxy)-4-(4′-(3″-sulfo-4″-aminoanthraquinone-1″-yl-amino)-anilino)-6-chloro-1,3,5-triazine; nitro-based polymerizable pigments such as o-nitroanilinomethyl (meth)acrylate; and phthalocyanine-based polymerizable pigments such as (meth)acryloyl tetraamino copper phthalocyanine, and (meth)acryloyl (dodecanoyl tetraamino copper phthalocyanine).

These polymerizable pigments can be used singly or in combination of two or more kinds.

Examples of the polymerizable ultraviolet absorbing pigment include benzophenone-based polymerizable ultraviolet absorbing pigments such as 2,4-dihydroxy-3(p-styrenoazo)benzophenone, 2,4-dihydroxy-5-(p-styrenoazo)benzophenone, 2,4-dihydroxy-3-(p-(meth)acryloyloxymethylphenylazo)benzophenone, 2,4-dihydroxy-5-(p-(meth)acryloyloxymethylphenylazo)benzophenone, 2,4-dihydroxy-3-(p-(meth)acryloyloxyethylphenylazo)benzophenone, 2,4-dihydroxy-5-(p-(meth)acryloyloxyethylphenylazo)benzophenone, 2,4-dihydroxy-3-(p-(meth)acryloyloxypropylphenylazo)benzophenone, 2,4-dihydroxy-5-(p-(meth)acryloyloxypropylphenylazo)benzophenone, 2,4-dihydroxy-3-(o-(meth)acryloyloxymethylphenylazo)benzophenone, 2,4-dihydroxy-5-(o-(meth)acryloyloxymethylphenylazo)benzophenone, 2,4-dihydroxy-3-(o-(meth)acryloyloxyethylphenylazo)benzophenone, 2,4-dihydroxy-5-(o-(meth)acryloyloxyethylphenylazo)benzophenone, 2,4-dihydroxy-3-(o-(meth)acryloyloxypropylphenylazo)benzophenone, 2,4-dihydroxy-5-(o-(meth)acryloyloxypropylphenylazo)benzophenone, 2,4-dihydroxy-3-(p-(N,N-di(meth)acryloyloxyethylamino)phenylazo)benzophenone, 2,4-dihydroxy-5-(p-(N,N-di(meth)acryloyloxyethylamino)phenylazo)benzophenone, 2,4-dihydroxy-3-(o-(N,N-di(meth)acryloyloxyethylamino)phenylazo)benzophenone, 2,4-dihydroxy-5-(o-(N,N-di(meth)acryloylethylamino)phenylazo)benzophenone, 2,4-dihydroxy-3-(p-(N-ethyl-N-(meth)acryloyloxyethylamino)phenylazo)benzophenone, 2,4-dihydroxy-5-(p-(N-ethyl-N-(meth)acryloyloxyethylamino)phenylazo)benzophenone, 2,4-dihydroxy-3-(o-(N-ethyl-N-(meth)acryloyloxyethylamino)phenylazo)benzophenone, 2,4-dihydroxy-5-(o-(N-ethyl-N-(meth)acryloyloxyethylamino)phenylazo)benzophenone, 2,4-dihydroxy-3-(p-(N-ethyl-N-(meth)acryloylamino)phenylazo)benzophenone, 2,4-dihydroxy-5-(p-(N-ethyl-N-(meth)acryloylamino)phenylazo)benzophenone, 2,4-dihydroxy-3-(o-(N-ethyl-N-(meth)acryloylamino)phenylazo)benzophenone, 2,4-dihydroxy-5-(o-(N-ethyl-N-(meth)acryloylamino)phenylazo)benzophenone, 2,4-dihydroxy-5-(4-(2-(N-(2-(meth)acryloyloxyethyl)carbamoyloxy)ethyl)phenylazo)benzophenone, and benzoate-based polymerizable ultraviolet absorbing pigments such as phenyl 2-hydroxy-4-(p-styrenoazo)benzoate.

These polymerizable ultraviolet absorbing pigments can be used singly or in combination of two or more kinds.

<Silicone Compound g>

The gel of the present invention may further contain a silicone compound (hereinafter, also referred to as silicone compound g) in addition to the aforementioned components. This imparts high oxygen permeability and flexibility to the obtained gel and lens.

As silicone compound g, besides silicone compound e having a polymerizable functional group, a non-polymerizable silicone compound (hereinafter, also referred to as non-polymerizable silicone compound h) is recited.

Concrete examples of silicone compound g include those expressed by the following formula (26) or (27) besides the examples recited as silicone compound e having a polymerizable functional group.

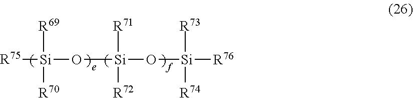

[In formula (26),

R⁶⁹ to R⁷⁶ independently represent a hydrogen atom, an alkyl group having 1 to 6 carbon atoms, an alkyl fluoride group, an alkyl group having at least one amino group, an alkyl group having at least one hydroxyl group, an alkyl group having at least one epoxy group, an alkyl group having at least one carboxyl group, or a phenyl group,

e represents an integer of 10 to 100, and

f represents an integer of 0 to 90, provided that e+f is an integer of 10 to 100.]

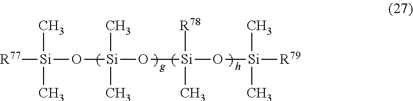

[In formula (27),

R⁷⁷ to R⁷⁹ independently represent a hydrogen atom, an alkyl group having 1 to 6 carbon atoms or a group expressed by the following formula (28),

g represents an integer of 5 to 100, and

h represents an integer of 0 to 100, provided that at least one of R⁷⁷ to R⁷⁹ is a group expressed by the following formula (28).]

CH₂₃OCH₂CH₂O_{d}R⁸⁰ (28)

[In formula (28),

R⁸⁰ represents a hydrogen atom or an alkyl group having 1 to 22 carbon atoms, and

d represents an integer of 1 to 100.]

The “alkyl group” in a hydrogen atom, an alkyl group having 1 to 6 carbon atoms, an alkyl fluoride group, an alkyl group having at least one amino group, an alkyl group having at least one hydroxyl group, an alkyl group having at least one epoxy group, an alkyl group having at least one carboxyl group represented by R⁶⁹ to R⁷⁶ in formula (26) is the same as the alkyl group represented by R⁶⁰ to R⁶⁵. Also the alkyl group having 1 to 6 carbon atoms represented by R⁷⁷ to R⁷⁹ in formula (27) is the same as the alkyl group represented by R⁶⁰ to R⁶⁵.

The alkyl fluoride group represented by R⁶⁹ to R⁷⁶ in formula (26) is the same as the alkyl fluoride group represented by R⁶⁰ to R⁶⁵.

The alkyl group having 1 to 22 carbon atoms represented by R⁸ in formula (28) may be straight-chained or branched-chained, and concrete examples include a methyl group, an ethyl group, a n-propyl group, an isopropyl group, a n-butyl group, an isobutyl group, a sec-butyl group, and a tert-butyl group.

Silicone compound e having a polymerizable functional group, and nonpolymerizable silicone compound h may have a hydrophilic partial structure in the molecule. By providing the silicon compound with a hydrophilic partial structure, compatibility between the silicone compound and polymer b is improved, and surface hydrophilicity of the obtained gel or lens can be improved. Examples of the hydrophilic partial structure include polyethylene glycol, polypropylene glycol, polyvinyl alcohol, polyvinylpyrrolidone, poly(meth)acrylic acid, poly(meth)acrylate, poly(2-hydroxyethyl (meth)acrylate), polytetrahydrofuran, polyoxetane, polyoxazoline, polyacrylamide, polydimethylacrylamide, polydiethylacrylamide, poly(2-methacryloyloxyethylphosphorylcholine), and partial structures derived from these block polymers. The hydrophilic partial structure may bind with the silicone compound in the form of a comb, or may bind either or both of the terminals of the silicone compound. The molecular weight of the hydrophilic partial structure is preferably 100 to 1,000,000, more preferably 1,000 to 500,000 from the viewpoint of surface hydrophilicity and transparency.

The content of silicone compound g is preferably 0 mass % or more, more preferably 0.01 mass % or more, further preferably 0.1 mass % or more, particularly preferably 1 mass % or more, relative to the total amount of the gel from the viewpoint of mechanical strength, transparency, oxygen permeability, for example, and is preferably 70 mass % or less, more preferably 60 mass % or less, further preferably 30 mass % or less, particularly preferably 10 mass % or less, relative to the total amount of the gel from the viewpoint of hydrophilizing ability, antifouling property imparting effect, lubricity imparting effect, for example.

### <Property Regulating Compound>

The gel of the present invention may contain a property regulating compound. Examples of the property regulating compound include nonpolymerizable property regulating compounds (hereinafter, also referred to as nonpolymerizable property regulating compound i) such as 2-(4,6-diphenyl-1,3,5-triazine-2-yl)-5-(hexyloxy)phenol, 2-(5-chloro-2H-benzotriazole-2-yl)-6-(1,1-dimethylethyl)-4-methylphenol besides property regulating compound f having a polymerizable functional group.

The gel of the present invention is excellent in surface hydrophilicity, lubricity and antifouling property (in particular, lipid antifouling property), and has high sustainability of these properties. Also, the gel of the present invention is excellent in gel strength, transparency, and oxygen permeability.

Therefore, the gel of the present invention is useful as a material for a culture base or a storage container of cells, organs, for example, as well as a material for ophthalmic lens. In particular, the gel of the present invention is useful as a contact lens material.

The ophthalmic lens used herein means a concept involving eyeglasses, intraocular lens, artificial cornea, corneal onlay, corneal inlay, for example, as well as contact lenses such as a soft contact lens, and a hard contact lens, and the contact lenses may be any of non-hydrous, low hydrous, and high hydrous contact lenses, and a silicone hydrogel contact lens is preferred. By using the gel of the present invention, it is possible to provide a silicone hydrogel contact lens that is excellent in surface hydrophilicity, lubricity and antifouling property (in particular, lipid antifouling property).

### [Lens]

The lens of the present invention is characterized by containing the gel of the present invention. As the lens, an ophthalmic lens is preferred, and a contact lens is more preferred.

In the case where the lens contains a fluorine-containing anion, the coefficient of linear expansion (hereinafter, also referred to as coefficient (I)) in water of the lens is preferably smaller than the coefficient of linear expansion (hereinafter, also referred to as coefficient (II)) in water of the lens in the case where the fluorine-containing anion is substituted with a non-fluorine-containing anion. Difference between coefficient (I) and coefficient (II) is preferably 0.005 to 0.1.

By setting the coefficient within such a range, the wearing feeling and the flexibility are improved when it is made into an ophthalmic lens, and it becomes easy to prevent an ocular disease from occurring.

### [Polymerizable Composition]

The polymerizable composition of the present invention is characterized by containing polymer a, hydrophilic monomer c, and crosslinking agent d. By using the polymerizable composition of the present invention, it is possible to obtain a gel that is excellent in surface hydrophilicity, lubricity and antifouling property, and has high sustainability of these properties.

The content of polymer a (modifying agent) is preferably 0.01 mass % or more, more preferably 0.1 mass % or more, further preferably 0.5 mass % or more, particularly preferably 1 mass % or more, relative to the total amount of the polymerizable composition from the viewpoint of hydrophilizing ability, antifouling property imparting effect, lubricity imparting effect, transparency and oxygen permeability, for example, and is preferably 40 mass % or less, more preferably 30 mass % or less, further preferably 20 mass % or less, particularly preferably 10 mass % or less, relative to the total amount of the polymerizable composition from the viewpoint of transparency and achieving appropriate hardness.

The content of hydrophilic monomer c is preferably 30 mass % or more, more preferably 40 mass % or more, relative to the total amount of the polymerizable composition from the viewpoint of hydrophilizing ability, stability, transparency, for example, and is preferably 95 mass % or less, more preferably 90 mass % or less, further preferably 80 mass % or less, relative to the total amount of the polymerizable composition from the viewpoint of oxygen permeability.

The content of crosslinking agent d is preferably 0.05 mass % or more, more preferably 0.1 mass % or more, relative to the total amount of the polymerizable composition from the viewpoint of flexibility, and is preferably 10 mass % or less, more preferably 7 mass % or less, relative to the total amount of the polymerizable composition from the viewpoint of mechanical strength and durability of the gel or lens.

The polymerizable composition of the present invention may contain silicone compound g, and a property regulating compound in addition to the above components. As silicone compound g, silicone compound e having a polymerizable functional group, and nonpolymerizable silicone compound h can be recited, and as a property regulating compound, property regulating compound f having a polymerizable functional group, and nonpolymerizable property regulating compound i can be recited.

The content of silicone compound g is preferably 0 mass % or more, more preferably 0.01 mass % or more, relative to the total amount of the polymerizable composition from the viewpoint of oxygen permeability and flexibility, and is preferably 70 mass % or less, more preferably 60 mass % or less, relative to the total amount of the polymerizable composition from the viewpoint of hydrophilizing ability, transparency, for example.

When alkyl (meth)acrylate or fluorine-containing alkyl (meth)acrylate is used as property regulating compound f having a polymerizable functional group, the content is preferably 0.01 to 20 mass %, more preferably 0.1 to 10 mass %, relative to the total amount of the polymerizable composition. When a hardness regulating monomer is used as property regulating compound f having a polymerizable functional group, the content is preferably 1 to 30 mass %, more preferably 3 to 20 mass %, relative to the total amount of the polymerizable composition. When a polymerizable ultraviolet absorber, a polymerizable pigment and a polymerizable ultraviolet absorbing pigment are used as property regulating compound f having a polymerizable functional group, the contents are preferably 0.01 to 3 mass %, more preferably 0.01 to 2 mass %, relative to the total amount of the polymerizable composition.

### [Manufacturing Method of Gel]

A manufacturing method of the gel containing a polymer of the present invention is characterized by obtaining polymer b through polymerization of hydrophilic monomer c with crosslinking agent d in the presence of polymer a. By synthesizing polymer b in this manner, such a condition that polymer a (modifying agent) in gel is held in the alternating network structure of polymer b arises, and gel with improved surface hydrophilicity, lubricity and antifouling property is prepared.

Hereinafter, methods for manufacturing the gel and the lens of the present invention will be concretely described.

For example, by subjecting a polymerizable composition (polymerizable composition of the present invention) that is prepared by admixing polymer a, hydrophilic monomer c and crosslinking agent d, and other components (silicone compound g or property regulating compound) as necessary to heating by a molding method and/or ultraviolet irradiation to cause copolymerization, and swelling in water, it is possible to obtain a gel and a lens of the present invention. Also, copolymerization can be conducted by electron beam irradiation in place of ultraviolet irradiation.

For heating polymerization of polymerizable components in the polymerizable composition, for example, the polymerizable composition and a radical polymerization initiator are added into a mold corresponding to a desired lens shape, and the mold is gradually heated to cause polymerization, and the obtained gel molded body is subjected to machining such as cutting, grinding as necessary, and thus the lens can be manufactured. The machining may be conducted on the entire surface of either one side or both sides of the molded body, or may be conducted part of the surface of either one side or both sides of the molded body.

As a polymerization method, a bulk polymerization method, and a solution polymerization method can be recited. Examples of the solvent used in the case of solution polymerization include alcohols having 1 to 4 carbon atoms such as methanol, ethanol, 1-propanol, and 2-propanol, and water-soluble organic solvents such as acetone, methylethylketone, dimethylformamide, dimethylsulfoxide, acetonitrile, and N-methyl-2-pyrrolidone. The use amount of these solvents is preferably 0.1 to 50 parts by mass, more preferably 0.5 to 15 parts by mass, relative to 100 parts by mass of all the polymerizable components in the polymerizable composition from the viewpoint of acceleration of copolymerization reaction and keeping of uniformity in the reaction solution.

Examples of the radical polymerization initiator include 2,2′-azobisisobutyronitrile, 2,2′-azobis(2,4-dimethylvaleronitrile), benzoylperoxide, t-butylhydroperoxide, cumenehydroperoxide, lauroylperoxide, t-butylperoxyhexanoate, and 3,5,5-trimethylhexanoylperoxide. These radical polymerization initiators can be used singly or in combination of two or more kinds.

The use amount of the radical polymerization initiator is preferably 0.001 to 2 parts by mass, more preferably 0.01 to 1 parts by mass, relative to 100 parts by mass of all the polymerizable components in the polymerizable composition.

The heating temperature in heating polymerization is preferably 50 to 150° C., more preferably 60 to 140° C. The heating time is preferably 10 to 120 minutes, more preferably 20 to 60 minutes. By setting the heating temperature in the mold at 50° C. or higher, or the heating time at 10 minutes or longer, it is possible to reduce the residual monomer components. On the other hand, by setting the temperature in the mold at 150° C. or less, or the heating time at 120 minutes or shorter, it is possible to prevent volatilization of each polymerizable component and prevent deformation of the mold.

For polymerization of polymerizable components in the polymerizable composition by ultraviolet irradiation, for example, the polymerizable composition and a photopolymerization initiator are added into a mold corresponding to a desired lens shape, and the mold is irradiated with ultraviolet light to cause polymerization, and the obtained gel molded body is subjected to machining such as cutting, grinding as necessary, and thus the lens can be manufactured. The machining may be conducted on the entire surface of either one side or both sides of the molded body, or may be conducted part of the surface of either one side or both sides of the molded body.

As a polymerization method, a bulk polymerization method, and a solution polymerization method can be recited. Examples of the solvent used in the case of solution polymerization are the same as those used in heating polymerization.

The material of the mold for use in polymerization by ultraviolet irradiation is not particularly limited insofar as it is a material through which the ultraviolet light required for polymerization and curing can penetrate, and commonly used resins such as polypropylene, polystyrene, nylon, and polyester are preferred. The material may be glass. By forming and processing these materials, a mold having a desired shape can be manufactured.

Examples of the photopolymerization initiator include phosphine oxide photopolymerization initiators such as 2,4,6-trimethylbenzoyl-diphenylphosphine oxide (TPO), and bis(2,4,6-trimethylbenzoyl)-phenyl phosphine oxide; benzoin photopolymerization initiators such as methylortho-benzoylbenzoate, methylbenzoylformate, benzoin methyl ether, benzoin ethyl ether, benzoin isopropyl ether, benzoin isobutyl ether, and benzoin-n-butyl ether; phenone photopolymerization initiators such as 2-hydroxy-2-methyl-1-phenylpropane-1-one, p-isopropyl-α-hydroxyisobutylphenone, p-t-butyltrichloroacetophenone, 2,2-dimethoxy-2-phenylacetophenone, α,α-dichloro-4-phenoxyacetophenone, N,N-tetraethyl-4,4-diaminobenzophenone, benzophenoneacrylate, and benzophenone; thioxanthone photopolymerization initiators such as

2-chlorothioxanthone, and 2-methylthioxanthone; and other photopolymerization initiators such as 1-hydroxycyclohexylphenylketone, 1-phenyl-1,2-propanedione-2-(o-ethoxycarbonyl)oxime, dibenzosuberone, and 2-ethylanthraquinone. These photopolymerization initiators can be used singly or in combination of two or more kinds. Also a photosensitizer may be used with the photopolymerization initiator.

Each of the use amounts of these photopolymerization initiator and photosensitizer is preferably 0.001 to 2 parts by mass, more preferably 0.01 to 1 parts by mass, relative to 100 parts by mass of all the polymerizable components in the polymerizable composition.

The wavelength range of the ultraviolet light can be appropriately selected depending on the function of the lens material or the kind of the photopolymerization initiator. The ultraviolet illuminance is preferably 1.0 to 50 mW/cm², and the ultraviolet irradiation amount is preferably 0.1 to 10 J/cm². The irradiation time of ultraviolet light is preferably 1 minute or more. Ultraviolet light of different illuminance may be radiated stepwise, or heating may be conducted simultaneously with irradiation with the ultraviolet irradiation.

For securing the stability and the mold releasability, hindered phenol-based or phosphite-based antioxidants; silicone-based, fatty acid ester-based, fatty acid-based, fatty acid glyceride-based or natural oil and fat-based lubricants or mold lubricants such as beeswax; benzotriazole-based, benzophenone-based, dibenzoylmethane-based or salicylate-based light stabilizers; antistatic agents such as polyalkyleneglycol and fatty acid glycerin; for example, may be appropriately added in advance to the polymerizable composition of the present invention, and then a polymerization reaction may be conducted as necessary.

The lens obtained in the manner as described above may be cleaned with water, a saline, a buffer, an organic solvent, or a mixed solvent thereof. Concretely, the lens can be dipped in such a solvent, and the dipping can be, for example, repeated.

The lens may be subjected to a low-temperature plasma treatment, an atmospheric pressure plasma treatment, a corona discharge treatment, for example. By conducting the low-temperature plasma treatment, surface hydrophilicity and antifouling property can be further improved.

The low-temperature plasma treatment can be conducted in an atmosphere of rarefied gas such as an alkane having 1 to 6 carbon atoms, an alkane substituted with fluorine, nitrogen, oxygen, argon, hydrogen, air, water, silane or a mixture of these. In particular, for the reason that a mechanical surface modifying effect by ion etching and a chemical surface modifying effect by implantation of radical are expected, it is preferred to conduct the low-temperature plasma treatment in an atmosphere of rarefied gas such as oxygen alone, or a mixture of oxygen, and water, tetrafluoromethane, organic silane, methane, nitrogen, for example. The low-temperature plasma treatment may be conducted in vacuo, or in an atmospheric pressure. In the low-temperature plasma treatment, by appropriately adjusting the output, treatment time, and gas concentration with high frequency RF (e.g., 13.56 MHz), low frequency AF (e.g., 15.0 to 40.0 KHz), and microwave (e.g., 2.45 GHz), the surface modifying effect can be controlled.

### [Polymer and Contact Lens Surface Modifier]

The polymer of the present invention is characterized by having repeat unit (A): 2.5 to 95 mass % and repeat unit (B): 2.5 to 95 mass %. The polymer is the above polymer a, and is useful as a contact lens surface modifying polymer, or a contact lens surface modifier.

(A) Hydrophilic repeat unit

(B) Repeat unit having a polyoxyalkylene group at a side chain thereof, the side chain having a terminal formed of an alkyl group having 5 to 30 carbon atoms, an alkanoyl group having 5 to 30 carbon atoms, or an aryl group

The contact lens surface modifier of the present invention is characterized by containing polymer a.

### EXAMPLES

Hereinafter, the present invention will be described in detail by way of Examples, however, it is to be noted that the present invention is not limited to these Examples.

Analytical conditions in Examples are as shown below.

### <Measurement of Molecular Weight>

Weight average molecular weight (Mw) and number average molecular weight (Mn) were measured by gel permeation chromatography (GPC) by using a TSK gel α-M column available from TOSOH CORPORATION, and using polystyrene as a standard, in the following analytical conditions: flow rate: 0.5 milliliters/min., eluting solvent: NMP solvent (H₃PO₄:0.016 M, LiBr: 0.030 M), and column temperature: 40° C.

### <NMR Spectrum>

¹H-NMR spectrum was measured by means of a model AVANCE 500 (500 MHz) available from BRUKER using d₆-DMSO as a solvent and an internal standard substance.

### Synthesis Example 1: Synthesis of Copolymer (N-1)

0.9 g of methoxypolyethylene glycol (9) monomethacrylate (M-90G (SHIN-NAKAMURA CHEMICAL CO., LTD), hereinafter, referred to as MPEGM), 1.85 g of lauroxypolyethylene glycol (30) monomethacrylate (PLE-1300 (available from NOF CORPORATION), hereinafter, referred to as LPEGM), 0.03 g of 2,2′-azobis(isobutyronitrile) as a polymerization initiator, and 12 g of Ekuamido B-100 (available from Idemitsu Kosan Co., Ltd.) as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-1).

In obtained copolymer (N-1), the content of the repeat unit derived from MPEGM was 35 mass %, the content of the repeat unit derived from LPEGM was 65 mass %. These contents were measured by ¹H-NMR.

Obtained copolymer (N-1) had a weight average molecular weight of 111000, a number average molecular weight of 23300, and a molecular weight distribution of 4.8.

### Synthesis Example 2: Synthesis of Copolymer (N-2)

1.20 g of MPEGM, 1.50 g of LPEGM, 0.30 g of 2-ethylhexyl acrylate (available from TOKYO CHEMICAL INDUSTRY CO., LTD.), 0.03 g of 2,2′-azobis(isobutyronitrile) as a polymerization initiator, and 12 g of Ekuamido B-100 (available from Idemitsu Kosan Co., Ltd.) as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-2).

In obtained copolymer (N-2), the content of the repeat unit derived from MPEGM was 40 mass %, the content of the repeat unit derived from LPEGM was 50 mass %, the content of the repeat unit derived from 2-ethylhexyl acrylate was 10 mass %. These contents were measured by ¹H-NMR.

Obtained copolymer (N-2) had a weight average molecular weight of 118000, a number average molecular weight of 33800, and a molecular weight distribution of 3.5.

### Synthesis Example 3: Synthesis of Copolymer (N-3)

2.03 g of MPEGM, 0.83 g of LPEGM, 0.14 g of silicone methacrylate expressed by the following formula (X) (available from TOKYO CHEMICAL INDUSTRY CO., LTD.), 0.03 g of 2,2′-azobis(isobutyronitrile) as a polymerization initiator, and 12 g of Ekuamido B-100 (available from Idemitsu Kosan Co., Ltd.) as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-3).

In obtained copolymer (N-3), the content of the repeat unit derived from MPEGM was 67.5 mass %, the content of the repeat unit derived from LPEGM was 27.5 mass %, and the content of the repeat unit derived from silicone methacrylate (X) was 5 mass %. These contents were measured by ¹H-NMR.

Obtained copolymer (N-3) had a weight average molecular weight of 133000, a number average molecular weight of 39400, and a molecular weight distribution of 3.4.

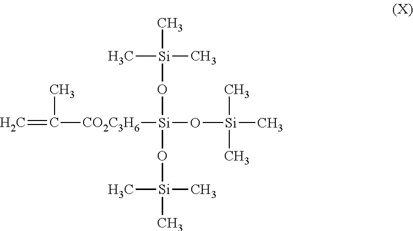

### Synthesis Example 4: Synthesis of Copolymer (N-4)

4.25 g of dimethylacrylamide ((available from KOHJIN CO., LTD.), hereinafter, referred to as DMAA), 0.125 g of N-methacryloyloxyethyl-N,N-dimethylammonium-α-N-methylcarboxybetaine (GLBT (available from OSAKA ORGANIC CHEMICAL INDUSTRY LTD.), hereinafter referred to as GLBT), 0.50 g of LPEGM, 0.125 g of N-dodecylacrylamide ((available from TOKYO CHEMICAL INDUSTRY CO., LTD.), hereinafter, referred to as DDAA), 0.05 g of 2,2′-azobis(isobutyronitrile) as a polymerization initiator, 31.05 g of acetonitrile (available from Mitsubishi Chemical) and 13.50 g of pure water as solvents were mixed and put into a flask. Nitrogen was blown into the flask, and the temperature of the mixture was raised to 60° C., and the mixture was allowed to polymerize for 6 hours, and then cooled to room temperature. The obtained solution was dialyzed against pure water, to obtain an aqueous solution of copolymer (N-4).

In obtained copolymer (N-4), the content of the repeat unit derived from DMAA was 85 mass %, the content of the repeat unit derived from GLBT was 2.5 mass %, the content of the repeat unit derived from LPEGM was 10 mass %, and the content of the repeat unit derived from DDAA was 2.5 mass %. These contents were measured by ¹H-NMR.

Obtained copolymer (N-4) had a weight average molecular weight of 515000, a number average molecular weight of 128000, and a molecular weight distribution of 4.2.

### Synthesis Example 5: Synthesis of Copolymer (N-5)

4.00 g of N-(2-hydroxyethyl)acrylamide ((available from KOHJIN CO., LTD.), hereinafter, referred to as HEAA), 5.00 g of LPEGM, 1.00 g of DDAA, 0.10 g of 2,2′-azobis(isobutyronitrile) as a polymerization initiator, and 39.10 g of isopropanol (available from Tokuyama Corporation) as a solvent were mixed and put into a flask. Nitrogen was blown into the flask, and the temperature of the mixture was raised to 60° C., and the mixture was allowed to polymerize for 6 hours, and then cooled to room temperature. The obtained solution was dialyzed against pure water, to obtain an aqueous solution of copolymer (N-5).

In obtained copolymer (N-5), the content of the repeat unit derived from HEAA was 40 mass %, the content of the repeat unit derived from LPEGM was 50 mass %, and the content of the repeat unit derived from DDAA was 10 mass %. These contents were measured by ¹H-NMR.

Obtained copolymer (N-5) had a weight average molecular weight of 32000, a number average molecular weight of 16000, and a molecular weight distribution of 2.0.

### Synthesis Example 6: Synthesis of Copolymer (N-6)

1.38 g of DMAA, 0.125 g of acrylic acid ((available from TOAGOSEI CO., LTD.), hereinafter, referred to as AA), 2.75 g of LPEGM, 0.75 g of DDAA, 0.05 g of 2,2′-azobis(isobutyronitrile) as a polymerization initiator, 31.05 g of acetonitrile (available from Mitsubishi Chemical) and 13.50 g of pure water as solvents were mixed and put into a flask. Nitrogen was blown into the flask, and the temperature of the mixture was raised to 60° C., and the mixture was allowed to polymerize for 6 hours, and then cooled to room temperature. After adding 0.153 g of sodium hydrogen carbonate to the obtained solution, the solution was dialyzed against pure water, to obtain a dispersion of copolymer (N-6).

In obtained copolymer (N-6), the content of the repeat unit derived from DMAA was 27.5 mass %, the content of the repeat unit derived from AA was 2.5 mass %, the content of the repeat unit derived from LPEGM was 55 mass %, and the content of the repeat unit derived from DDAA was 15 mass %. These contents were measured by ¹H-NMR.

Obtained copolymer (N-6) had a weight average molecular weight of 430000, a number average molecular weight of 108000, and a molecular weight distribution of 4.0.

### Synthesis Example 7: Synthesis of Copolymer (N-7)

10.0 g of MPEGM, 25.0 g of LPEGM, 15.0 g of silicone methacrylate expressed by the above formula (X) (available from TOKYO CHEMICAL INDUSTRY CO., LTD.), 0.25 g of 2,2′-azobis(isobutyronitrile) as a polymerization initiator, and 200 g of acetonitrile as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-7).

In obtained copolymer (N-7), the content of the repeat unit derived from MPEGM was 20 mass %, the content of the repeat unit derived from LPEGM was 50 mass %, and the content of the repeat unit derived from silicone methacrylate (X) was 30 mass %. These contents were measured by ¹H-NMR.

Obtained copolymer (N-7) had a weight average molecular weight of 91000, a number average molecular weight of 50500, and a molecular weight distribution of 1.8.

### Synthesis Example 8: Synthesis of Copolymer (N-8)

2.0 g of HEAA, 5.0 g of LPEGM, 3.0 g of silicone methacrylate expressed by the above formula (X) (available from Tokyo Chemical Industry Co., Ltd.), 0.07 g of 2,2′-azobis(isobutyronitrile) as a polymerization initiator, and 39.93 g of ethanol as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-8).

In obtained copolymer (N-8), the content of the repeat unit derived from HEAA was 20 mass %, the content of the repeat unit derived from LPEGM was 50 mass %, and the content of the repeat unit derived from silicone methacrylate (X) was 30 mass %. These contents were measured by ¹H-NMR.

Obtained copolymer (N-8) had a weight average molecular weight of 48000, a number average molecular weight of 15000, and a molecular weight distribution of 3.2.

### Synthesis Example 9: Synthesis of Copolymer (N-9)

2.25 g of DMAA, 0.125 g of GLBT, 2.50 g of LPEGM, 0.125 g of DDAA, 0.5 g of 2,2′-azobis(isobutyronitrile) as a polymerization initiator, 31.05 g of acetonitrile (available from Mitsubishi Chemical) and 13.50 g of pure water as solvents were mixed and put into a flask. Nitrogen was blown into the flask, and the temperature of the mixture was raised to 60° C., and the mixture was allowed to polymerize for 6 hours, and then cooled to room temperature. The obtained solution was dialyzed against pure water, to obtain an aqueous solution of copolymer (N-9).

In obtained copolymer (N-9), the content of the repeat unit derived from DMAA was 45 mass %, the content of the repeat unit derived from GLBT was 2.5 mass %, the content of the repeat unit derived from LPEGM was 50 mass %, and the content of the repeat unit derived from DDAA was 2.5 mass %. These contents were measured by ¹H-NMR.

Obtained copolymer (N-9) had a weight average molecular weight of 47000, a number average molecular weight of 11500, and a molecular weight distribution of 4.1.

### Synthesis Example 10: Synthesis of Copolymer (N-10)

0.25 g of DMAA, 0.125 g of GLBT, 4.50 g of LPEGM, 0.125 g of DDAA, 0.5 g of 2,2′-azobis(isobutyronitrile) as a polymerization initiator, 31.05 g of acetonitrile (available from Mitsubishi Chemical) and 13.50 g of pure water as solvents were mixed and put into a flask. Nitrogen was blown into the flask, and the temperature of the mixture was raised to 60° C., and the mixture was allowed to polymerize for 6 hours, and then cooled to room temperature. The obtained solution was dialyzed against pure water, to obtain a dispersion of copolymer (N-10).

In obtained copolymer (N-10), the content of the repeat unit derived from DMAA was 5 mass %, the content of the repeat unit derived from GLBT was 2.5 mass %, the content of the repeat unit derived from LPEGM was 90 mass %, and the content of the repeat unit derived from DDAA was 2.5 mass %. These contents were measured by ¹H-NMR.

Obtained copolymer (N-10) had a weight average molecular weight of 35000, a number average molecular weight of 10400, and a molecular weight distribution of 3.4.

### Synthesis Example 11: Synthesis of Copolymer (N-11)

15.0 g of MPEGM, 30.0 g of LPEGM, 5.0 g of silicone methacrylate expressed by the above formula (X) (available from TOKYO CHEMICAL INDUSTRY CO., LTD.), 0.5 g of 2,2′-azobis(isobutyronitrile) as a polymerization initiator, and 200 g of acetonitrile as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain an aqueous solution of copolymer (N-11).

In obtained copolymer (N-11), the content of the repeat unit derived from MPEGM was 30 mass %, the content of the repeat unit derived from LPEGM was 60 mass %, and the content of the repeat unit derived from silicone methacrylate (X) was 10 mass %. These contents were measured by ¹H-NMR.

Obtained copolymer (N-11) had a weight average molecular weight of 50000, a number average molecular weight of 26000, and a molecular weight distribution of 1.9.

### Synthesis Example 12: Synthesis of Copolymer (N-12)

5.0 g of MPEGM, 20.0 g of LPEGM, 25.0 g of silicone methacrylate expressed by the above formula (X) (available from TOKYO CHEMICAL INDUSTRY CO., LTD.), 0.5 g of 2,2′-azobis(isobutyronitrile) as a polymerization initiator, and 200 g of acetonitrile as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-12).

In obtained copolymer (N-12), the content of the repeat unit derived from MPEGM was 10 mass %, the content of the repeat unit derived from LPEGM was 40 mass %, and the content of the repeat unit derived from silicone methacrylate (X) was 50 mass %. These contents were measured by ¹H-NMR.

Obtained copolymer (N-12) had a weight average molecular weight of 43000, a number average molecular weight of 20000, and a molecular weight distribution of 2.2.

### Synthesis Example 13: Synthesis of Copolymer (N-13)

3.0 g of HEAA, 6.0 g of LPEGM, 1.0 g of silicone methacrylate expressed by the above formula (X) (available from TOKYO CHEMICAL INDUSTRY CO., LTD.), 0.07 g of 2,2′-azobis(isobutyronitrile) as a polymerization initiator, and 39.93 g of ethanol as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain an aqueous solution of copolymer (N-13).

In obtained copolymer (N-13), the content of the repeat unit derived from HEAA was 30 mass %, the content of the repeat unit derived from LPEGM was 60 mass %, and the content of the repeat unit derived from silicone methacrylate (X) was 10 mass %. These contents were measured by ¹H-NMR.

Obtained copolymer (N-13) had a weight average molecular weight of 45000, a number average molecular weight of 15000, and a molecular weight distribution of 3.0.

### Synthesis Example 14: Synthesis of Copolymer (N-14)

1.0 g of HEAA, 4.0 g of LPEGM, 5.0 g of silicone methacrylate expressed by the above formula (X) (available from TOKYO CHEMICAL INDUSTRY CO., LTD.), 0.07 g of 2,2′-azobis(isobutyronitrile) as a polymerization initiator, and 39.93 g of ethanol as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain a dispersion of copolymer (N-14).

In obtained copolymer (N-14), the content of the repeat unit derived from HEAA was 10 mass %, the content of the repeat unit derived from LPEGM was 40 mass %, and the content of the repeat unit derived from silicone methacrylate (X) was 50 mass %. These contents were measured by ¹H-NMR.

Obtained copolymer (N-14) had a weight average molecular weight of 48300, a number average molecular weight of 13200, and a molecular weight distribution of 3.7.

### Reference Example 1: Synthesis of Copolymer (N-15)

2.85 g of MPEGM, 0.15 g of 2-ethylhexyl acrylate (available from TOKYO CHEMICAL INDUSTRY CO., LTD.), 0.03 g of 2,2′-azobis(isobutyronitrile) as a polymerization initiator, and 12 g of Ekuamido B-100 (available from Idemitsu Kosan Co., Ltd.) as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain an aqueous solution of copolymer (N-15).

In obtained copolymer (N-15), the content of the repeat unit derived from MPEGM was 95 mass %, and the content of the repeat unit derived from 2-ethylhexyl acrylate was 5 mass %. These contents were measured by ¹H-NMR.

Obtained copolymer (N-15) had a weight average molecular weight of 115000, a number average molecular weight of 26800, and a molecular weight distribution of 4.3.

### Reference Example 2: Synthesis of Copolymer (N-16)

2.40 g of DMAA, 0.60 g of 2-ethylhexyl acrylate (available from TOKYO CHEMICAL INDUSTRY CO., LTD.), 0.03 g of 2,2′-azobis(isobutyronitrile) as a polymerization initiator, and 12 g of Ekuamido B-100 (available from Idemitsu Kosan Co., Ltd.) as a solvent were mixed and put into a flask. Nitrogen was blown into the flask, and the temperature of the mixture was raised to 70° C., and the mixture was allowed to polymerize for 8 hours, and then cooled to room temperature. The obtained solution was dialyzed against pure water, to obtain an aqueous solution of copolymer (N-16).

In obtained copolymer (N-16), the content of the repeat unit derived from DMAA was 80 mass %, and the content of the repeat unit derived from 2-ethylhexyl acrylate was 20 mass %. These contents were measured by ¹H-NMR.

Obtained copolymer (N-16) had a weight average molecular weight of 49000, a number average molecular weight of 14300, and a molecular weight distribution of 3.4.

For example, physical properties of copolymers (N-1) to (N-16) are shown in the following Tables 1 and 2.

TABLE 1

| | (A) | | | | | (B) | (C) | | |
|---|---|---|---|---|---|---|---|---|---|
| (mass %) | MPEGM | DMAA | HEAA | GLBT | AA | LPEGM | 2-EHA(*1) | DDAA | Si-MA(*2) |
| Synthesis example 1 (N-1) | 35 | — | — | — | — | 65 | — | — | — |
| Synthesis example 2 (N-2) | 40 | — | — | — | — | 50 | 10 | — | — |
| Synthesis example 3 (N-3) | 67.5 | — | — | — | — | 27.5 | — | — | 5 |
| Synthesis example 4 (N-4) | — | 85 | — | 2.5 | — | 10 | — | 2.5 | — |
| Synthesis example 5 (N-5) | — | — | 40 | — | — | 50 | — | 10 | — |
| Synthesis example 6 (N-6) | — | 27.5 | — | — | 2.5 | 55 | — | 15 | — |
| Synthesis example 7 (N-7) | 20 | — | — | — | — | 50 | — | — | 30 |
| Synthesis example 8 (N-8) | — | — | 20 | — | — | 50 | — | — | 30 |
| Synthesis example 9 (N-9) | — | 45 | — | 2.5 | — | 50 | — | 2.5 | — |
| Synthesis example 10 (N-10) | — | 5 | — | 2.5 | — | 90 | — | 2.5 | — |
| Synthesis example 11 (N-11) | 30 | — | — | — | — | 60 | — | — | 10 |
| Synthesis example 12 (N-12) | 10 | — | — | — | — | 40 | — | — | 50 |
| Synthesis example 13 (N-13) | — | — | 30 | — | — | 60 | — | — | 10 |
| Synthesis example 14 (N-14) | — | — | 10 | — | — | 40 | — | — | 50 |
| Reference example 1 (N-15) | 95 | — | — | — | — | — | 5 | — | — |
| Reference example 2 (N-16) | — | 80 | — | — | — | — | 20 | — | — |

(*1)2-ethylhexyl acrylate,
(*2)silicone methacrylate (X)

TABLE 2

| | | Weight molecular |
|---|---|---|
| | HLB | weight (Mw) |
| Synthesis example 1 (N-1) | 15.0 | 111000 |
| Synthesis example 2 (N-2) | 13.5 | 118000 |
| Synthesis example 3 (N-3) | 14.6 | 133000 |
| Synthesis example 4 (N-4) | 21.4 | 515000 |
| Synthesis example 5 (N-5) | 19.5 | 32000 |
| Synthesis example 6 (N-6) | 15.4 | 430000 |
| Synthesis example 7 (N-7) | 12.1 | 91000 |
| Synthesis example 8 (N-8) | 15.2 | 48000 |
| Synthesis example 9 (N-9) | 18.5 | 47000 |
| Synthesis example 10 (N-10) | 15.6 | 35000 |
| Synthesis example 11 (N-11) | 14.1 | 50000 |
| Synthesis example 12 (N-12) | 10.0 | 43000 |
| Synthesis example 13 (N-13) | 18.5 | 45000 |
| Synthesis example 14 (N-14) | 11.6 | 48300 |
| Reference example 1 (N-15) | 14.4 | 115000 |
| Reference example 2 (N-16) | 17.6 | 49000 |

### Example 1: Preparation of Gel

A 0.5 mass % dispersion of copolymer (N-1) in water was lyophilized to obtain solids of copolymer (N-1). Then, 50 parts by mass of silicone methacrylate expressed by the following formula (X) (available from TOKYO CHEMICAL INDUSTRY CO., LTD.), 40 parts by mass of DMAA (available from KOHJIN CO., LTD.), 5 parts by mass of polyethylene glycol dimethacrylate (n≈4 (available from Tokyo Chemical Industry Co., Ltd.), 5 parts by mass of copolymer (N-1), and 1 part by mass of 2,2-dimethoxy-2-phenylacetophenone were mixed, and flown into a glass laboratory dish, and the mixture was subjected to UV irradiation at a UV irradiation amount 1.5 J/cm² in an ambient atmosphere to obtain a polymer. The polymer was swelled with ion exchange water, and washed three times with PBS. Then the polymer was autoclave-sterilized in PBS to obtain a polymer-added silicone hydrogel.

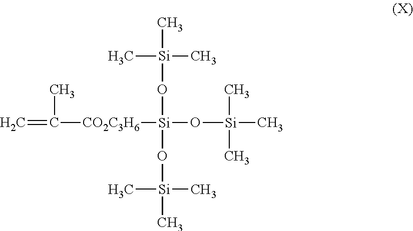

### Examples 2 to 14: Preparation of Gel

A polymer-added silicone hydrogel was obtained in the same manner as in Example 1 except that the 0.5 mass % dispersion of copolymer (N-1) in water was changed to a 0.5 mass % dispersion or solution in water of copolymers (N-2) to (N-14).

### Comparative Examples 1 to 2: Preparation of Gel

A polymer-added silicone hydrogel was obtained in the same manner as in Example 1 except that the 0.5 mass % dispersion of copolymer (N-1) in water was changed to a 0.5 mass % solution in water of copolymers (N-15) to (N-16).

### Comparative Example 3: Preparation of Gel

50 parts by mass of silicone methacrylate expressed by the above formula (X) (available from TOKYO CHEMICAL INDUSTRY CO., LTD.), 40 parts by mass of DMAA (available from KOHJIN CO., LTD.), 5 parts by mass of polyethylene glycol dimethacrylate (n≈4 (available from Tokyo Chemical Industry Co., Ltd.), 5 parts by mass of Poloxamer 407, and 1 part by mass of 2,2-dimethoxy-2-phenylacetophenone were mixed, and flown into a glass laboratory dish, and the mixture was subjected to UV irradiation at a UV irradiation amount 1.5 J/cm² in an ambient atmosphere to obtain a polymer. The polymer was swelled with ion exchange water, and washed three times with PBS. Then the polymer was autoclave-sterilized in PBS to obtain a polymer-added silicone hydrogel.

### Test Example 1: Surface Hydrophilicity Test for Polymer-Added Silicone Hydrogel

Polymer-added silicone hydrogel obtained in Example and Comparative Example was taken out from PBS, and evaluated according to the following criteria. A higher rank in the evaluation criteria indicates more excellent surface hydrophilicity. The test results are shown in Table 3.

### (Surface Hydrophilicity Evaluation Criteria)

### Ranking

1: Silicone hydrogel surface little gets wet, and repels water.
2: Wetting of half or more of area of silicone hydrogel surface is nonuniform, and water is slightly repelled
3: Half or more of area of silicone hydrogel surface uniformly gets wet
4: Silicone hydrogel surface uniformly gets wet

### Test Example 2: Lubricity Test for Polymer-Added Silicone Hydrogel

Prior to the test, a gel to be used as a control in the lubricity test (control gel) was prepared. To be more specific, 50 parts by mass of silicone methacrylate expressed by the above formula (X) (available from TOKYO CHEMICAL INDUSTRY CO., LTD.), 45 parts by mass of DMAA (available from KOHJIN CO., LTD.), 5 parts by mass of polyethylene glycol dimethacrylate (n≈4 (available from Tokyo Chemical Industry Co., Ltd.), and 1 part by mass of 2,2-dimethoxy-2-phenylacetophenone were mixed, and flown into a glass laboratory dish, and the mixture was subjected to UV irradiation at a UV irradiation amount 1.5 J/cm² in an ambient atmosphere to obtain a polymer. The polymer was swelled with ion exchange water, and washed three times with PBS. Then the polymer was autoclave-sterilized in PBS to obtain a control gel.

For each polymer-added silicone hydrogel obtained in Examples and Comparative Examples, lubricity in touching with a dry finger was evaluated according to the criteria of the ranks 1 to 4 shown below by ten subjects, and a mean value of the lubricity ranking was calculated. A higher rank in the evaluation criteria indicates more excellent lubricity. The test results are shown in Table 3.

### (Lubricity Evaluation Criteria)

### Ranking

1: Comparable with control gel
2: Slightly having lubricity as compared with control gel
3: Wholly no creaking, and having lubricity, compared with control gel
4: Wholly no creaking, and having greater lubricity, compared with control gel

TABLE 3

| | | Surface | |
|---|---|---|---|
| | Polymer | hydrophilicity | Lubricity |
| Control | — | 1 | 1 |

| | | | | |
|---|---|---|---|---|
| Example | 1 | N-1 | 2 | 2.2 |
| | 2 | N-2 | 2 | 2.5 |
| | 3 | N-3 | 3 | 3.1 |
| | 4 | N-4 | 4 | 3.6 |
| | 5 | N-5 | 3 | 2.9 |
| | 6 | N-6 | 4 | 3.3 |
| | 7 | N-7 | 3 | 2.9 |
| | 8 | N-8 | 3 | 2.9 |
| | 9 | N-9 | 4 | 3.4 |
| | 10 | N-10 | 3 | 2.7 |
| | 11 | N-11 | 3 | 2.8 |
| | 12 | N-12 | 3 | 3.3 |
| | 13 | N-13 | 4 | 3.7 |
| | 14 | N-14 | 3 | 3 |
| Comparative | 1 | N-15 | 1 | 1.5 |
| Example | 2 | N-16 | 1 | 1.8 |
| | 3 | Poloxamer | 2 | 2 |
| | | 407 | | |

As shown in Table 3, the gels of Examples 1 to 14 were excellent in surface hydrophilicity and lubricity. This result reveals that by adding the polymers of Synthesis examples 1 to 14 in preparation of silicone hydrogels, excellent surface hydrophilicity and lubricity are imparted.

Gels of Examples 3 to 14 were particularly excellent in surface hydrophilicity.

### Test Example 3: Lipid Antifouling Property Test

Prior to the test, 1.20 mass % of oleic acid, 1.20 mass % of linoleic acid, 16.23 mass % of tripalmitin, 4.01 mass % of cetyl alcohol, 1.20 mass % of palmitic acid, 16.23 mass % of cetyl palmitate, 1.60 mass % of cholesterol, 1.60 mass % of cholesterol palmitate and 56.71 mass % of lecithin were homogenized by stirring under heating to obtain a lipid liquid, and 0.5 parts by mass of the lipid liquid and 99.5 parts by mass of water were mixed and emulsified to prepare an artificial lipid solution. Then, each polymer-added silicone hydrogel obtained in

Examples and Comparative Examples was dipped in 1 mL of the artificial lipid solution, and shaken for 1 hours, and then taken out, and washed three times with PBS, and dried in vacuo. Thereafter, the silicone hydrogel was dipped in 1 mL of ethanol/diethyl ether (75/25 vol %) solution, and stood still for 30 minutes, and thus lipids remaining on the silicone hydrogel was extracted. 0.5 mL of this extract was sampled in a test tube, and the solvent was evaporated at 90° C.

Then 0.5 mL of concentrated sulfuric acid was added to the test tube, and heated at 90° C. for 30 minutes. After cooling the solution to room temperature, 2.5 mL of 0.6 mass % vanillin aqueous solution/phosphoric acid (20/80 vol %) solution was added, and retained at 37° C. for 15 minutes. This solution was cooled to room temperature, and then absorbance at 540 nm was measured. A solution of a known lipid concentration was measured in the same manner as described above, and a calibration curve was prepared in advance, and the lipid amount adsorbed to the silicone hydrogel was determined from the absorbance of the measurement result.

The test results are shown in Table 4. The control in the table shows the result of the test carried out in the same manner as described above using the control gel obtained in Test example 2 in place of the silicone hydrogel. The lipid antifouling amount shows reduced lipid adhesion amount compared with the control, and it can be said that the larger the value, the higher the lipid antifouling property.

TABLE 4

| | | Lipid antifouling |
|---|---|---|
| | Polymer | amount (μg) |
| Control | — | 0 |

| | | | |
|---|---|---|---|
| Example | 1 | N-1 | 2 |
| | 2 | N-2 | 3 |
| | 3 | N-3 | 4 |
| | 4 | N-4 | 4 |
| | 5 | N-5 | 4 |
| | 6 | N-6 | 4 |
| | 7 | N-7 | 3 |
| | 8 | N-8 | 4 |
| | 9 | N-9 | 4 |
| | 10 | N-10 | 4 |
| | 11 | N-11 | 4 |
| | 12 | N-12 | 3 |
| | 13 | N-13 | 4 |
| | 14 | N-14 | 3 |
| Comparative | 1 | N-15 | 0 |
| Example | 2 | N-16 | 0 |
| | 3 | Poloxamer 407 | 1 |

As shown in Table 4, the gels of Examples 1 to 14 were excellent in lipid antifouling property. This result reveals that by adding the polymers of Synthesis examples 1 to 14 in preparation of silicone hydrogels, excellent lipid antifouling property is imparted.

The gels of Examples 2 to 14 were particularly excellent in lipid antifouling property.

1: A gel comprising:
a polymer a having 2.5 to 95 mass % of a repeat unit (A), and 2.5 to 95 mass % of a repeat unit (B), and
a polymer b obtained through polymerization of a hydrophilic monomer with a crosslinking agent,
wherein:
the repeat unit (A) is a hydrophilic repeat unit, and
the repeat unit (B) is a repeat unit having a polyoxyalkylene group at a side chain thereof, the side chain having a terminal formed of an alkyl group having 5 to 30 carbon atoms, an alkanoyl group having 5 to 30 carbon atoms, or an aryl group.

2: The gel according to claim 1, wherein the hydrophilic monomer is polymerized with the crosslinking agent in the presence of the polymer a.

3: The gel according to claim 1, wherein the repeat unit (A) is one or more selected from the group consisting of:
a repeat unit (A-1) having a polyoxyalkylene group at a side chain thereof, the side chain having a terminal formed of a hydrogen atom or an alkyl group having 1 to 4 carbon atoms,
a repeat unit (A-2) expressed by formula (3),
a repeat unit (A-3) expressed by formula (4),
a repeat unit (A-4) expressed by formula (5),
a repeat unit (A-5) expressed by formula (6),
a betainic repeat unit (A-6) expressed by formula (7),
an anionic repeat unit (A-7), and
a cationic repeat unit (A-8) expressed by formula (8): 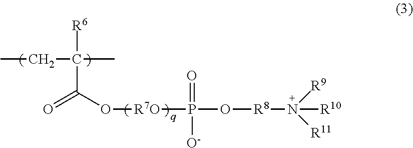
wherein in formula (3),
R⁶ represents a hydrogen atom or a methyl group,
R⁷ represents an alkanediyl group having 2 to 4 carbon atoms,
R⁸ represents an alkanediyl group having 1 to 10 carbon atoms,
R⁹, R¹⁰ and R¹¹ independently represent a hydrogen atom or a hydrocarbon atom having 1 to 8 carbon atoms, and
q represents 1 to 10 at an average value, 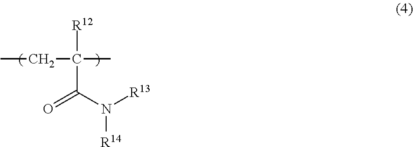
wherein in formula (4),
R¹² represents a hydrogen atom or a methyl group, and
R¹³ and R¹⁴ independently represent a hydrogen atom, an alkyl group having 1 to 6 carbon atoms or a hydroxyalkyl group, 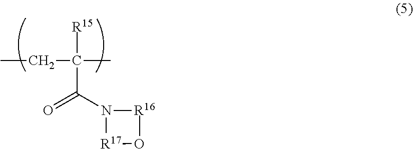
wherein in formula (5),
R¹⁵ represents a hydrogen atom or a methyl group, and
R¹⁶ and R¹⁷ independently represent an alkanediyl group having 1 to 3 carbon atoms, 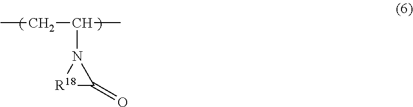
wherein in formula (6),
R¹¹ represents an alkanediyl group having 1 to 5 carbon atoms, 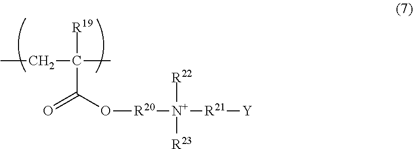
wherein in formula (7),
Y represents —(C═O)O⁻, —(O═S═)O⁻, —O(O═S═)O⁻, —(S═O)O⁻, —O(S═O)O⁻, —OP(═O)(OR²⁴)O⁻, —OP(═O)(R²⁴)O⁻, —P(═O)(OR²⁴)O⁻, or —P(═O)(R²⁴)O⁻, where R²⁴ represents an alkyl group having 1 to 3 carbon atoms,
R¹⁹ represents a hydrogen atom or a methyl group,
R²⁰ and R²¹ independently represent a bivalent organic group having 1 to 10 carbon atoms, and
R²² and R²³ independently represent a hydrocarbon having 1 to 10 carbon atoms, and 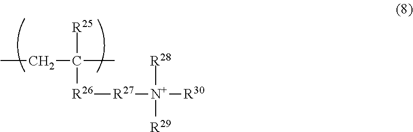
wherein in formula (8),
R²⁵ represents a hydrogen atom or a methyl group,
R²⁶ represents —O—, *—(C═O)—O—, *—(C═O)—NR³¹—, or *—NR³—(C═O)—, where R³¹ represents a hydrogen atom or an organic group having 1 to 10 carbon atoms, and * represents a position of binding with a carbon atom to which R²⁵ in formula (8) binds, or R²⁶ represents a phenylene group,
R²⁷ represents a bivalent organic group having 1 to 10 carbon atoms, and
R²⁸, R²⁹ and R³⁰ independently represent a hydrocarbon having 1 to 10 carbon atoms.

4: The gel according to claim 3, wherein the repeat unit (A) comprises the repeat unit (A-1), and the repeat unit (A-1) is expressed by formula (2): 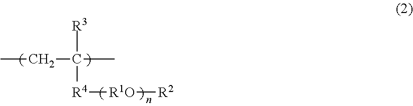
wherein in formula (2),
R¹ represents an alkanediyl group having 2 to 4 carbon atoms,
R² represents a hydrogen atom or an alkyl group having 1 to 4 carbon atoms,
R³ represents a hydrogen atom or a methyl group,
R⁴ represents —O—, *—(C═O)—O—, *—(C═O)—NR⁵—, or *—NR⁵—(C═O)—, where R⁵ represents a hydrogen atom or an organic group having 1 to 10 carbon atoms, * represents a position of binding with a carbon atom to which R³ in formula (2) binds, or R⁴ represents a phenylene group, and
n represents 2 to 100 at an average value.

5: The gel according to claim 1, wherein the repeat unit (B) is a repeat unit having a polyoxyalkylene group at a side chain thereof, and the terminal of the side chain is formed of an alkyl group having 5 to 30 carbon atoms, or an alkanoyl group having 5 to 30 carbon atoms.

6: The gel according to claim 1, wherein the repeat unit (B) is expressed by formula (10): 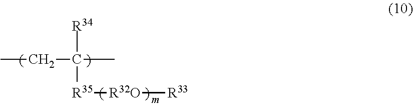
wherein in formula (10),
R³² represents an alkanediyl group having 2 to 4 carbon atoms,
R³³ represents an alkyl group having 5 to 30 carbon atoms, an alkanoyl group having 5 to 30 carbon atoms, or an aryl group,
R³⁴ represents a hydrogen atom or a methyl group,
R³⁵ represents —O—, **—(C═O)—O—, **—(C═O)—NR³⁶—, or **—NR³⁶—(C═O)—, where R³⁶ represents a hydrogen atom or an organic group having 1 to 10 carbon atoms, ** represents a position of binding with a carbon atom to which R³⁴ in formula (10) binds, or R³⁵ represents a phenylene group, and
m represents 2 to 100 at an average value.

7: The gel according to claim 1, wherein the polymer a further has 60% by mass or less of one or more repeat unit (C) selected from the group consisting of:
a repeat unit (C-1) expressed by formula (11), and
a repeat unit (C-2) having a group expressed by formula (12) at the terminal of a side chain: 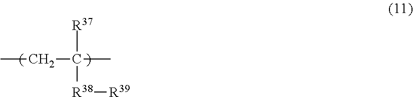
wherein in formula (11),
R³⁷ represents a hydrogen atom or a methyl group,
R³⁸ represents —O—, ***—(C═O)—O—, ***—(C═O)—NR⁴⁰—, or ***—NR⁴⁰—(C═O)—, where R⁴⁰ represents a hydrogen atom or an organic group having 1 to 10 carbon atoms, *** represents a position of binding with a carbon atom to which R³⁷ in formula (11) binds, or R³⁸ represents a phenylene group, and
R³⁹ represents a hydrocarbon group having 4 to 30 carbon atoms, and 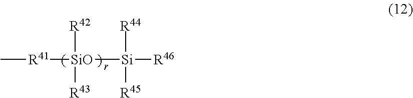
wherein in formula (12),
R⁴¹ represents a bivalent organic group having 1 to 10 carbon atoms,
R⁴² and R⁴³ independently represent an organic group having 1 to 10 carbon atoms,
R⁴⁴, R⁴⁵ and R⁴⁶ independently represent —OSi(R⁴⁹)₃, where each R⁴⁹ independently represents a hydrogen atom or an organic group having 1 to 8 carbon atoms, or R⁴⁴, R⁴⁵ and R⁴⁶ independently represent an organic group having 1 to 10 carbon atoms, and
r represents 0 to 200 at an average value.

8: The gel according to claim 1, wherein the polymer a is a non-network polymer.

9: The gel according to claim 1, comprising 0.01 to 40 mass % of the polymer a.

10: The gel according to claim 1, further comprising a silicone compound.

11: The gel according to claim 1, wherein the polymer b is obtained through polymerization of a silicone compound having a polymerizable functional group with the hydrophilic monomer and the crosslinking agent.

12: A method for manufacturing a gel comprising a polymer, the method comprising:
polymerizing a hydrophilic monomer with a crosslinking agent to give a polymer, in the presence of a polymer a having a repeat unit (A) in an amount of 2.5 to 95 mass % and a repeat unit (B) in an amount of 2.5 to 95 mass %,
wherein:
the repeat unit (A) is a hydrophilic repeat unit, and
the repeat unit (B) is a repeat unit having a polyoxyalkylene group at a side chain thereof, the side chain having a terminal formed of an alkyl group having 5 to 30 carbon atoms, an alkanoyl group having 5 to 30 carbon atoms, or an aryl group.

13: A lens comprising the gel according to claim 1.

14: The lens according to claim 13, which is a contact lens.

15: A contact lens surface modifier comprising:
a polymer a having 2.5 to 95 mass % of a repeat unit (A), and 2.5 to 95 mass % of a repeat unit (B),
wherein:
the repeat unit (A) is a hydrophilic repeat unit, and
the repeat unit (B) is a repeat unit having a polyoxyalkylene group at a side chain thereof, the side chain having a terminal formed of an alkyl group having 5 to 30 carbon atoms, an alkanoyl group having 5 to 30 carbon atoms, or an aryl group.

16: A polymerizable composition comprising:
a polymer a having 2.5 to 95 mass % of a repeat unit (A), and 2.5 to 95 mass % of a repeat unit (B),
a hydrophilic monomer, and
a crosslinking agent,
wherein:
the repeat unit (A) is a hydrophilic repeat unit, and
the repeat unit (B) is a repeat unit having a polyoxyalkylene group at a side chain thereof, the side chain having a terminal formed of an alkyl group having 5 to 30 carbon atoms, an alkanoyl group having 5 to 30 carbon atoms, or an aryl group.

17: A polymer having 2.5 to 95 mass % of a repeat unit (A), and 2.5 to 95 mass % of a repeat unit (B),
wherein:
the repeat unit (A) is a hydrophilic repeat unit, and
the repeat unit (B) is a repeat unit having a polyoxyalkylene group at a side chain thereof, the side chain having a terminal formed of an alkyl group having 5 to 30 carbon atoms, an alkanoyl group having 5 to 30 carbon atoms, or an aryl group.
